(19) United States
(12) Patent Application Publication
(10) Pub. No.: US 2022/0317343 A1
(43) Pub. Date: Oct. 6, 2022

(54) ACTIVE LENS CONTROL SYSTEMS AND METHODS

(71) Applicants: CORNING INCORPORATED, CORNING, NY (US); LG INNOTEK CO., LTD, GANGSEO-GU (KR)

(72) Inventors: Raymond Miller Karam, Santa Barbara, CA (US); Dragan Pikula, Horseheads, NY (US); Farzaneh Rasti Najafabadi, Goleta, CA (US); Daniel Ohen Ricketts, Corning, NY (US)

(21) Appl. No.: 17/615,930

(22) PCT Filed: Jun. 1, 2020
(86) PCT No.: PCT/US2020/035515

§ 371 Date: Dec. 2, 2021

Related U.S. Application Data
(60) Provisional application No. 62/856,687, filed on Jun. 3, 2019.
(60) Provisional application No. 62/871,961, filed on Jul. 9, 2019.

(51) Int. Cl. G02B 3/14; G02B 7/02

(52) U.S. Cl. CPC G02B 3/14; G02B 7/028; G02B 2207/115

(57) ABSTRACT

A variable focus lens system can include a variable focus lens, one or more electrodes, a signal generator configured to supply voltage to the one or more electrodes to vary the focal length of the variable focus lens, and a controller configured to apply a voltage to the one or more electrodes and receive information indicative of a capacitance that results from the applied voltage. The controller can be configured to determine a temperature of the variable focus lens based at least in part on the capacitance or applied voltage. The variable focus lens system can include a temperature sensor, and the controller can be configured to receive temperature information from the temperature sensor and calibrate the temperature sensor based at least in part on the received temperature information, the applied voltage, and the received capacitance information.

### CROSS-REFERENCE TO RELATED APPLICATIONS

This application claims the benefit of priority under 35 U.S.C. § 119 of U.S. Provisional Application Nos. 62/856,687, filed Jun. 3, 2019, and 62/871,961, filed Jul. 9, 2019, the content of each of which is incorporated herein by reference in its entirety.

### BACKGROUND

### Field of the Disclosure

Some embodiments of this disclosure relate to active lenses (e.g., liquid lenses), including control systems and control methods for active lenses. Some embodiments relate to electrical control systems.

### Description of the Related Art

Although various liquid lenses and other active lenses are known, there remains a need for improved active lenses and associated control methods and systems.

### SUMMARY

Disclosed herein are active lenses and control systems and methods for active lenses.

Disclosed herein is a liquid lens system comprising a chamber, a first fluid in the chamber, a second fluid in the chamber, a first electrode insulated from the first and second fluids, a second electrode in electrical communication with the first fluid, a signal generator configured to supply a voltage differential between the first electrode and the second electrode, wherein a position of an interface between the first fluid and the second fluid is based at least in part on voltage differentials applied between the first electrode and the second electrode, a sensor configured to output information that is indicative of a capacitance between at least the first fluid and the first electrode, and a controller configured to apply a voltage differential between the first electrode and the second electrode, receive information indicative of a capacitance that results from applying the voltage differential, and determine a temperature of the liquid lens based at least in part on the applied voltage differential and the information indicative of the resulting capacitance.

Disclosed herein is a liquid lens system comprising a chamber, a first fluid in the chamber, a second fluid in the chamber, a first electrode insulated from the first and second fluids, a second electrode in electrical communication with the first fluid, a signal generator configured to apply a voltage differential between the first electrode and the second electrode, wherein a position of an interface between the first fluid and the second fluid is based at least in part on voltage differential applied between the first electrode and the second electrode, and a controller configured to access a target optical power, access a temperature of the liquid lens and determine a target capacitance based at least in part on the target optical power and the temperature of the liquid lens.

Disclosed herein is a variable focus lens system comprising a variable focus lens, one or more electrodes, a signal generator configured to supply voltage to the one or more electrodes to vary the focal length of the variable focus lens, and a controller configured to apply a voltage to the one or more electrodes, receive information indicative of a capacitance that results from the applied voltage, and determine a temperature of the variable focus lens based at least in part on the capacitance or applied voltage.

Disclosed herein is a variable focus lens system comprising a variable focus lens, one or more electrodes, wherein a focal length of the variable focus lens is adjustable by supplying voltage to the one or more electrodes, a temperature sensor, and a controller configured to apply a voltage to the one or more electrodes, receive capacitance information indicative of a capacitance that results from the applied voltage, receive temperature information from the temperature sensor, and calibrate the temperature sensor based at least in part on the received temperature information, the applied voltage, and the received capacitance information.

### BRIEF DESCRIPTION OF THE DRAWINGS

FIG. 1 is a cross-sectional view of some examples of a liquid lens.

FIG. 2 is a cross-sectional view of some embodiments of a liquid lens with a flexed upper window.

FIG. 3 is a plan view of some embodiments of a liquid lens.

FIG. 4 is a cross-sectional view taken through opposing electrodes 22a and 22c of the liquid lens of FIG. 3.

FIG. 5 is a block diagram of some embodiments of a camera system, which can include a liquid lens.

FIG. 6 is a plot showing some embodiments of how the relationship between optical power and capacitance is affected by temperature.

FIG. 7 is a plot showing some embodiments of target capacitance values that can be used to produce various optical powers between −5 and 25 diopters at various temperatures between 10 degrees C. and 60 degrees C.

FIG. 8 is a flowchart of some embodiments of a method for controlling a liquid lens.

FIG. 9 is a flowchart of some embodiments of a method for controlling a liquid lens.

FIG. 10 is a flowchart of some embodiments of a method for controlling a liquid lens.

FIG. 11 is a flowchart of some embodiments of a method for controlling a liquid lens.

FIG. 12 is a plot showing some embodiments of how the relationship between applied voltage and resulting capacitance can vary with changes in temperature.

FIG. 13 is a flowchart of some embodiments for determining a temperature of a liquid lens.

FIG. 14 is a flowchart of some embodiments of a method for determining a target capacitance for controlling a liquid lens.

FIG. 15 is a plot showing some embodiments of determining an initial or reference voltage and expected or reference capacitance based on a target optical power.

FIG. 16 is a plot showing some embodiments of determining the difference between a reference temperature and an actual temperature of a liquid lens based on the difference between an expected or reference capacitance and an actual measured capacitance.

FIG. 17 is a flowchart of some embodiments of a method for controlling a liquid lens.

FIG. 18 is a flowchart of some embodiments of a method for controlling a liquid lens.

FIG. 19 is a flowchart of some embodiments of a method for controlling a liquid lens.

FIG. 20 is a block diagram of some embodiments of an approach for controlling a liquid lens for optical power and tilt.

FIG. 21 is a block diagram of some embodiments of an approach for determining tilt voltage offsets for four electrodes of a liquid lens.

FIG. 22 shows some embodiments of tilt voltages for electrodes of a liquid lens being combined with focus control voltage values to produce final voltage values for the driving electrodes.

FIG. 23 is a block diagram of some embodiments of a system for controlling a liquid lens.

FIG. 24 is a plot of some embodiments of charge current over time for a lens electrode.

FIG. 25 is a flowchart of some embodiments of a method for calibrating a temperature sensor for an active lens system, which can have a liquid lens or other variable focus lens.

FIG. 26 is a plot of some embodiments of capacitance changing over time when temperature and voltage are constant.

FIG. 27 is a plot showing some embodiments of capacitance over a period of time.

FIG. 28 is a flowchart of some embodiments of a method for calibrating a temperature sensor for an active lens system, which can have a liquid lens or other variable focus lens.

FIG. 29 is a flowchart of some embodiments of a method for calibrating voltage parameters for a lens system, which can have a liquid lens or other variable focus lens.

FIG. 30 is a flowchart of some embodiments of a method for calibrating a lens system, which can have a liquid lens or other variable focus lens.

FIG. 31 is a flowchart of some embodiments of a method for operating a lens system, which can have a liquid lens or other variable focus lens.

FIG. 32 is a flowchart of some embodiments of a method for operating a lens system, which can have a liquid lens or other variable focus lens.

### DETAILED DESCRIPTION OF CERTAIN EMBODIMENTS

### Liquid Lens System

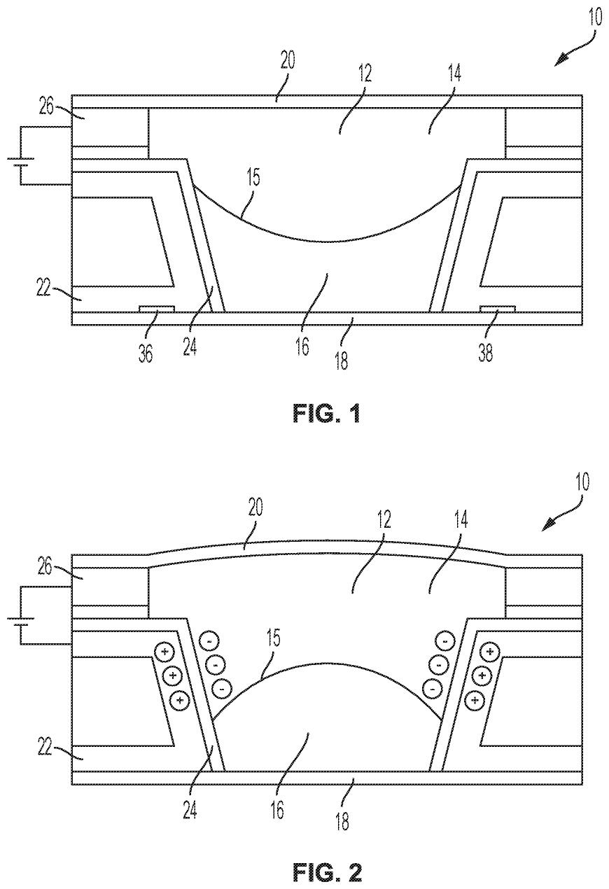

FIG. 1 is a cross-sectional view of an example embodiment of a liquid lens 10. The liquid lens 10 can have a cavity 12 that contains at least two fluids (e.g., liquids), such as first fluid 14 and a second fluid 16. The two fluids can be substantially immiscible so that a fluid interface 15 is formed between the first fluid 14 and the second fluid 16. Although some embodiments disclosed herein show a fluid interface 15 between two fluids that directly contact each other, the interface 15 can be formed by a membrane or other intermediate structure or material between the two fluids 14 and 16. For example, embodiments disclosed herein can be modified to use various fluids, such as those that could mix if in direct contact. In some embodiments the two fluids 14 and 16 can be sufficiently immiscible such as to form the fluid interface 15. The interface 15, when curved for example, can refract light with optical power as a lens. The first fluid 14 can be electrically conductive, and the second fluid 16 can be electrically insulating. The first fluid 14 can be a polar fluid, such as an aqueous solution, in some embodiments. The second fluid 16 can be an oil, in some embodiments. The first fluid 14 can have a higher dielectric constant than the second fluid 16. The first fluid 14 and the second fluid 16 can have different indices of refraction, for example so that light can be refracted at it passes through the fluid interface 15. The first fluid 14 and the second fluid 16 can have substantially similar densities, which can impede either of the fluids 14 and 16 from floating relative to the other.

The cavity 12 can include a portion having a shape of a frustum or truncated cone. The cavity 12 can have angled side walls. The cavity 12 can have a narrow portion where the side walls are closer together and a wide portion where the side walls are further apart. The narrow portion can be at the bottom end of the cavity 12 and the wide portion can be at the top end of the cavity 12 in the orientation shown, although the liquid lenses 10 disclosed herein can be positioned at various other orientations. The edge of the fluid interface 15 can contact the angled side walls of the cavity 12. The edge of the fluid interface 15 can contact the portion of the cavity 12 having the frustum or truncated cone shape. Various other cavity shapes can be used. For example, the cavity can have curved side walls (e.g., curved in the cross-sectional view of FIGS. 1-2). The side walls can conform to the shape of a portion of a sphere, toroid, or other geometric shape. In some embodiments, the cavity 12 can have a cylindrical shape. The cavity 12 can have different portions with different side wall angles, or the side walls can have a uniform side wall angle, as shown in FIGS. 1 and 2. In some embodiments, the cavity can have a flat (e.g., planar) surface and the fluid interface can contact the flat surface (e.g., as a drop of the second fluid 16 sitting on the base of the cavity 12).

A lower window 18, which can include a transparent plate, can be below the cavity 12. An upper window 20, which can include a transparent plate, can be above the cavity 12. The lower window 18 can be located at or near the narrow portion of the cavity 12, and/or the upper window 20 can be located at or near the wide portion of the cavity 12. The lower window 18 and/or the upper window 20 can be configured to transmit light therethrough. The lower window 18 and/or the upper window 20 can transmit sufficient light to form an image, such as on an imaging sensor of a camera. In some cases, the lower window 18 and/or the upper window 20 can absorb and/or reflect a portion of the light that impinges thereon. In some embodiments, one or both of the windows 18 and 20 can flex or move, for example so that the internal volume of the chamber or cavity 12 can change, such as to account for thermal expansion as the temperature of the liquid lens changes. FIG. 2, for example shows an example of a flexed upper window 20. One or both of the windows 18 and 20 (or the surrounding areas) can have regions of different thicknesses or other configurations that can influence the flexing or movement of the corresponding window 18 or 20.

A first one or more electrodes 22 (e.g., insulated electrodes or driving electrodes) can be insulated from the fluids 14 and 16 in the cavity 12, such as by an insulation material 24. A second one or more electrodes 26 can be in electrical communication with the first fluid 14. The second one or more electrodes 26 can be in contact with the first fluid 14. In some embodiments, the second one or more electrodes 26 can be capacitively coupled to the first fluid 14. Voltages can be applied between the electrodes 22 and 26 to control the shape of the interface 15 between the fluids 14 and 16, such as to vary the focal length of the liquid lens 10. Direct current (DC) voltage signals can be provided to one or both of the electrodes 22 and 26. Alternating current (AC) voltage signals can be provided to one or both of the electrodes 22 and 26. The liquid lens 10 can respond to the root mean square (RMS) voltage signal resulting from the AC voltage(s) applied. In some embodiments, AC voltage signals can impede charge from building up in the liquid lens 10, which can occur in some instances with DC voltages. In some embodiments, the first fluid 14 and/or the second one or more electrodes 26 can be grounded. In some embodiments, the first one or more electrodes 22 can be grounded. In some embodiments, voltage can be applied to either the first electrode(s) 22 or the second electrode(s) 26, but not both, to produce voltage differentials. In some embodiments, voltage signals can be applied to both the first electrode(s) 22 and the second electrode(s) 26 to produce voltage differentials.

FIG. 1 shows the liquid lens 10 in a first state where no voltage is applied between the electrodes 22 and 26, and FIG. 2 shows the liquid lens 10 in a second state where a voltage is applied between the electrodes 22 and 26. The chamber 12 can have one or more side walls made of a hydrophobic material. For example the insulating material 24 can be parylene, which can be insulating and hydrophobic, although various other suitable materials can be used. When no voltage is applied, the hydrophobic material on the side walls can repel the first fluid 14 (e.g., an aqueous solution) so that the second fluid 16 (e.g., an oil) can cover a relatively large area of the side walls to produce the fluid interface 15 shape shown in FIG. 1. When a voltage is applied between the first electrode 22 and the first fluid 14 (e.g., via the second electrode 26), the first fluid 14 can be attracted to the first electrode 22, which can drive the location of the fluid interface 15 down the side wall so that more of the side walls are is in contact with the first fluid 14. Changing the applied voltage differential can change the contact angle between the edge of the fluid interface 15 and the surface of the cavity 12 (e.g., the angled side wall of the truncated cone portion of the cavity 12) based on the principle of electrowetting. The fluid interface 15 can be driven to various different positions by applying different amounts of voltage between the electrodes 22 and 26, which can produce different focal lengths or different amounts of optical power for the liquid lens 10.

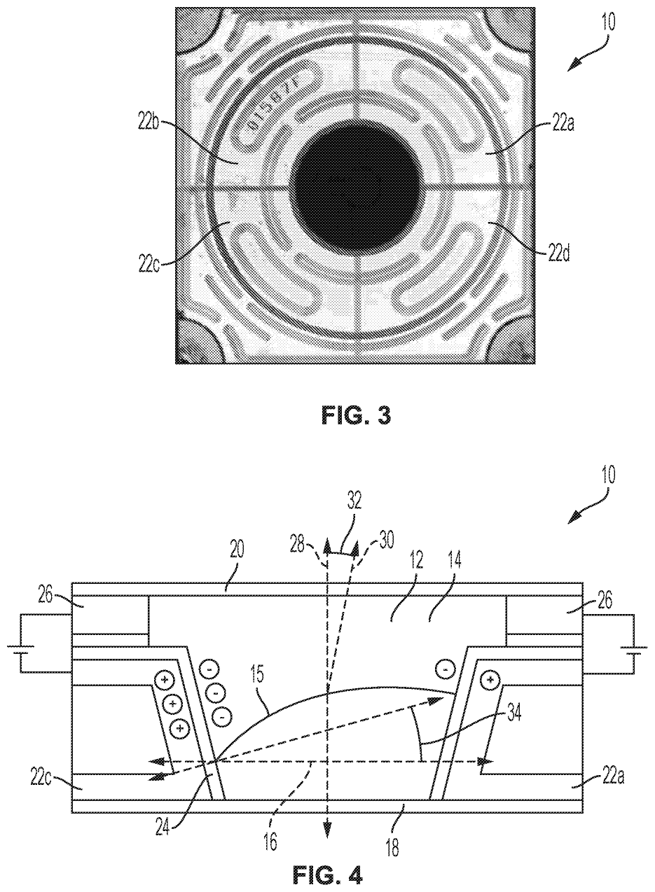

FIG. 3 shows a plan view of an example embodiment of a liquid lens 10. In some embodiments, the first one or more electrodes 22 (e.g., insulated electrodes) can include multiple electrodes 22 positioned at multiple locations on the liquid lens 10. The liquid lens 10 can have four electrodes 22a, 22b, 22c, and 22d, which can be positioned in four quadrants of the liquid lens 10. In other embodiments, the first one or more electrodes 22 can include various numbers of electrodes (e.g., 1 electrode, 2 electrodes, 4 electrodes, 6 electrodes, 8 electrodes, 12 electrodes, 16 electrodes, 32 electrodes, or more, or any values therebetween). Although various examples are provided herein with even numbers of insulated electrodes 22, odd numbers of insulated electrodes 22 can also be used. The electrodes 22a-d can be driven independently (e.g., having the same or different voltages applied thereto), which can be used to position the fluid interface 15 at different locations on the different portions (e.g., quadrants) of the liquid lens 10. FIG. 4 shows a cross-sectional view taken through opposing electrodes 22a and 22c. If more voltage is applied to the electrode 22c than to the electrode 22a, as shown in FIG. 4, the fluid interface 15 can be pulled further down the sidewall at the quadrant of the electrode 22c than at the quadrant of the electrode 22a.

The tilted fluid interface 15 can turn light that is transmitted through the liquid lens 10. The liquid lens 10 can have an axis 28. The axis 28 can be an axis of symmetry for at least a portion of the liquid lens 10. For example, the cavity 12 can be substantially rotationally symmetrical about the axis 28. The truncated cone portion of the cavity 12 can be substantially rotationally symmetrical about the axis 28. The axis 28 can be an optical axis of the liquid lens 10. For example, the curved and untilted fluid interface 15 can converge light towards, or diverge light away from, the axis 28. The axis 28 can be a longitudinal axis of the liquid lens 10, in some embodiments. Tilting the fluid interface 15 can turn the light 30 passing through the tilted fluid interface relative to the axis 28 by an optical tilt angle 32. The light 30 that passed through the tilted fluid interface 15 can converge towards, or diverge away from, a direction that is angled by the optical tilt angle 32 relative to the direction along which the light entered the liquid lens 10. The fluid interface 15 can be tilted by physical tilt angle 34 that produces the optical tilt angle 32. The relationship between the optical tilt angle 32 and the physical tilt angle 34 depends at least in part on the indices of refraction of the fluids 14 and 16.

The optical tilt angle 32 produced by tilting the fluid interface 15 can be used by a camera system to provide optical image stabilization, off-axis focusing, etc. In some cases different voltages can be applied to the electrodes 22a-d to compensate for forces applied to the liquid lens 10 so that the liquid lens 10 maintains on-axis focusing. Voltages can be applied to control the curvature of the fluid interface 15, to produce a desired optical power or focal length, and the tilt of the fluid interface 15, to produce a desired optical tilt (e.g., an optical tilt direction and an amount of optical tilt). Accordingly, the liquid lens 10 can be used in a camera system to produce a variable focal length while simultaneously producing optical image stabilization.

### Camera System

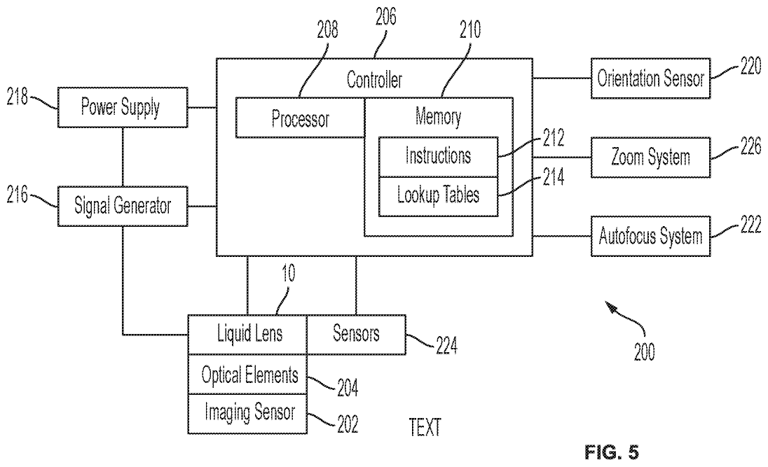

FIG. 5 is a block diagram of an example embodiment of a camera system 200, which can include a liquid lens 10, which can include features of any of the liquid lens embodiments disclosed herein. The camera system 200 can include an imaging sensor 202, which can be used to produce an image from light that impinges on the imaging sensor 202. The imaging sensor 202 can be a charge-coupled device (CCD) sensor, a complementary metal-oxide semiconductor (CMOS) sensor, or any other suitable electronic imaging sensor. In some embodiments, photographic film can be used to produce an image, or any other suitable type of imaging sensor. The liquid lens 10 can direct light toward the imaging sensor 202. In some embodiments, the camera system 200 can include one or more additional optical elements 204 that operate on the light propagating toward the imaging sensor 202. The optical elements 204 can include one or more fixed lenses (e.g., a fixed lens stack), one or more movable lenses, one or more optical filters, or any other suitable optical elements for producing desired optical effects. The liquid lens 10 can operate on the light propagating towards the imaging sensor 202 before the one or more optical elements 204, after the one or more optical elements 204, or the liquid lens 10 can be positioned optically between optical elements 204. When light is described herein as propagating towards a component (e.g., towards the imaging sensor 202), the light can be propagating along a path that directly or indirectly leads to the component. For example, light can pass through the liquid lens 10 in a first direction while propagating along an optical path towards the imaging sensor 202, and the light can be redirected (e.g., reflected by a mirror and/or turned by refraction) to continue in a second direction (which can be different than, and even opposite to, the first direction) along the optical path towards the imaging sensor 202.

The camera system 200 can include a controller 206 for operating the liquid lens 10, in some cases other optical elements 204, and/or other components of the system 200, for example to implement the liquid lens features and/or other functionality disclosed herein. The controller 206 can operate various aspects of the camera system 200. For example, a single controller 206 can operate the liquid lens 10, can operate the imaging sensor 202, can store images produced by the imaging sensor 202, and/or can operate other components of the camera, such as a display, a shutter, a user interface, etc. In some embodiments, any suitable number of controllers can be used to operate the various aspects of the camera system 200. The controller 206 can output voltage signals to the liquid lens 10. For example, the controller 206 can output voltage signals to the insulated electrode(s) 22 and/or the electrode(s) 26 in electrical communication with the first (e.g., conductive) fluid 14, and the voltage signals can control the curvature of the fluid interface 15 (e.g., to produce a desired optical power) and/or to control the tilt of the fluid interface 15 (e.g., to produce a desired optical tilt). The controller 206 can output DC voltage signals, AC voltage signals, pulsed DC voltage signals, or any other suitable signals for driving the liquid lens 10.

The controller 206 can include at least one processor 208. The processor 208 can be a hardware processor. The processor 208 can be a computer processor. The processor 208 can be in communication with a computer-readable memory 210. The memory 210 can be non-transitory computer-readable memory. The memory 210 can include one or more memory elements, which can be of the same or different types. The memory 210 can include a hard disk, flash memory, RAM memory, ROM memory, or any other suitable type of computer-readable memory. The processor 206 can execute computer-readable instructions 212 stored in the memory 210 to implement the functionality disclosed herein. In some embodiments, the processor 208 can be a general purpose processor. In some embodiments, the processor 208 can be a specialized processor that is specially configured to implement the functionality disclosed herein. The processor 208 can be an application specific integrated circuit (ASIC) and/or can include other circuitry configured to perform the functionality disclosed herein, such as to operate the liquid lens 10 as discussed herein.

The memory 210 can include one or more lookup tables 214, which can be used in determining the voltage signals to be applied to the liquid lens 10. The processor 208 can be configured to implement, and/or the computer-readable instructions 212 can include, one or more algorithms, equations, or formulas to be used in determining the voltage signals to be applied to the liquid lens 10. The processor 208 can determine the voltages to be applied to the liquid lens 10 (e.g., using one or more lookup tables 214 and/or one or more algorithms, equations, or formulas). Other information can be stored in the memory 210, such as images produced by the camera system 200, instructions for operating other components of the camera system 200, etc.

The system 200 can include a signal generator 216, which can generate the voltage signals to be provided to the liquid lens 10. The signal generator 216 can generate the voltage signals in response to the voltage values determined by the controller 206 (e.g., using the processor 208). The signal generator 216 can include one or more amplifiers, switches, H-bridges, half-bridges, rectifiers, and/or any other suitable circuitry for producing the voltage signals. A power supply 218 can be used to produce the voltage signals to be provided to the liquid lens 10. The power supply 218 can be a battery, a DC power source, an AC power source, or any suitable source of electrical power. The power supply 218 can provide electrical power for operation of the processor 208, memory 2010, the imaging sensor 202, active optical elements 204, and/or other electronic components of the system 200. The signal generator 216 can receive power from the power supply 218 and can modulate or otherwise modify the electrical signals (e.g., based on determinations made by the processor 208) to provide driving signals to the liquid lens 10. In some embodiments, at least some components of the controller 206 (e.g., processor 208) and the signal generator 216 can be implemented together in a single integrated circuit (IC) or in combined circuitry.

In some embodiments, the controller 206 can receive input from an orientation or motion sensor 220, such as a gyroscope, accelerometer, and/or other suitable sensor for providing information regarding the orientation or motion of the camera system 200 and/or the liquid lens 10. In some embodiments, the orientation sensor 220 can be a MEMS (micro-electro-mechanical system) device. The orientation sensor 220 can provide a measurement of angular velocity, acceleration, or any suitable measurement that can be used to determine a desired optical tilt for the liquid lens 10. In some cases, when the camera system 200 shakes (e.g., in response to being held by a human, vibrations from a driving car, etc.) the orientation sensor 220 (e.g., gyroscope) can provide input to the controller 206 regarding the shaking, and the liquid lens 10 can be driven to at least partially counter the shaking of the camera system 200 by controlling the tilt of the fluid interface 15 (e.g., tilt direction and amount of tilt).

The controller 206 (e.g., using the processor 208) can determine an optical tilt amount (e.g., angle 32) and/or an optical tilt direction (e.g., an azimuthal angle) based at least in part on the input received from the orientation sensor 220, although in some embodiments these parameters can be received by the liquid lens controller 206 (e.g., determined by the orientation sensor 220 or some other component of the camera system 200). The signals for driving the liquid lens 10 (e.g., voltage signals) can be determined at least in part based on the optical tilt amount and/or optical tilt direction. In some cases, the controller 206 (e.g., using the processor 208) can determine a physical tilt amount (e.g., angle 34) and/or a physical tilt direction (e.g., an azimuthal angle) for the fluid interface 15. These can be determined from the optical tilt amount and/or optical tilt direction, or can be determined directly from the input received from the orientation sensor 220. The controller 206 (e.g., using the processor 208) can determine driver signals (e.g., voltages) for the electrodes (e.g., the insulated electrodes 22a-d in the embodiment of FIG. 3) to implement the physical or optical tilt of the fluid interface 15. In some embodiments, the driver signals can be determined from the input received from the orientation sensor 220 directly, such as without determining the desired optical tilt, without determining the desired physical tilt of the fluid interface 15, and/or without determining other intermediate values or parameters.

Many variations are possible. In some embodiments, the orientation sensor 220 can be omitted. For example, the camera system 200 can perform optical image stabilization (OIS) in response to image analysis or any other suitable approach. The controller 206 can receive OIS input information (e.g., derived by any suitable approach), and can control tilt of the fluid interface 15 in response to that OIS input information. In some cases, the lens tilt can be used for purposes other than OIS, such as for off-axis imaging. By way of example, the camera system 200 can zoom into a portion of the image that is not located at the center of the image. Controlling the tilt of the fluid interface 15 of the liquid lens 10 can, at least in part, be used to control the direction and amount of offset from center for the optical zoom. In some cases, the off-axis imaging can be used to expand the viewing range of the camera system 200. Although, not shown in FIG. 5, various embodiments disclosed herein can include two liquid lenses, such as for implementing an optical zoom function. The controller 206 can receive focal direction input information (e.g., for OIS or off-axis imaging), and can control tilt of the fluid interface 15 in response to that focal direction input information.

The controller 206 can receive optical power information. The input optical power information can include a target optical power (e.g., diopters) a target focal length, or other information that can be used to determine the curvature for the fluid interface 15. The optical power information can be determined by an autofocus system 222 of the camera system 200, can be set by input from a user (e.g., provide to a user interface of the camera system 200), or provided from any other source. In some embodiments, the controller 206 can determine the optical power information. For example, the controller 206 can be used to implement the autofocus system 222 that determines a desired optical power or focal length. In some cases, the controller 206 can receive the optical power information and can determine a corresponding optical power for the liquid lens 10, for example since the other optical elements 204 can also affect the optical power (e.g., statically or dynamically). The controller 206 (e.g., using the processor 208) can then determine driver signal(s) (e.g., voltages) for the electrode(s) to control the curvature of the fluid interface 15. In some cases, the controller 206 can determine the driver signal(s) directly from autofocus data or directly from optical power information, such as without determining a value for the optical power of the liquid lens and/or without determining other intermediate values.

The controller 206 (e.g., using the processor 208) can use the focal direction information (e.g., OIS information, orientation information, shake information, etc.) and the focal length information (e.g., optical power information, autofocus information, etc.) together to determine the driver signal(s) for the liquid lens 10. For example, the driver signals to produce 1 degree of optical tilt and 3 diopters of optical power can be different than the driver signals to produce 1 degree of optical tilt and 5 diopters of optical power, which can be different still from the driver signals to produce 2 degrees of optical tilt and 5 diopters of optical power. Various lookup tables 214, formulas, equations, and/or algorithms can be used to determine the driver signals based on both the focal length information and the focal direction information.

The controller 206 can receive zoom information from a zoom system 226, in some implementations. The zoom information can include user input, such as a command for an amount of zoom. The zoom information can be determined by any other suitable manner, and from any other suitable source. The zoom information can be used to determine a focal length for one or more liquid lenses 10, and/or a position for one or more movable lens elements 204. In some embodiments, the system can include multiple liquid lenses 10. The zoom information, can be used with the autofocus information, and/or with optical image stabilization information to determine parameters for the camera system 200 such as the liquid lens focal length, liquid lens tilt, position of a movable lens element, etc.

The system can include one or more sensors 224, in some implementations. One or more sensors 224 can provide information indicative of the position of the interface 15 of the liquid lens 10. The sensors 224 can provide information regarding the fluid interface position for each of the insulated electrodes 22a-d. For example, the one or more sensors 224 can provide information indicative of the capacitance between at least the corresponding one or more insulated electrodes 22a-d and the first fluid 14. In some embodiments, the controller 206 can receive feedback and can drive the liquid lens 10 based at least in part on the feedback. The controller 206 can use a closed loop control scheme for driving the liquid lens 10, in some implementations. In some embodiments, the controller 206 can use a PID control scheme, an open loop control scheme, feed forward control scheme, any other suitable approach for controlling the liquid lens 10, or combinations thereof.

In some embodiments, the sensors 224 can include one or more temperature sensors, which can measure a temperature of the liquid lens 10. In some cases, the system can include a heater (not shown in FIG. 5), which can provide heat to the liquid lens 10. The heater and temperature sensor can be used to control the temperature of the liquid lens 10, such as using a feedback control approach. By way of example, FIG. 1 shows an example liquid lens with a temperature sensor 36 configured to measure a temperature in the liquid lens 10. In some embodiments, the temperature sensor 36 can be embedded in the liquid lens 10. For example, the temperature sensor 36 can be disposed between two layers of the liquid lens construction. A conductive lead can extend from the embedded location of the temperature sensor 36 to a periphery of the liquid lens 10, such as for providing and/or receiving signals from the temperature sensor. The temperature sensor 36 can comprise a thermocouple, a resistive temperature device (RTD), a thermistor, an infrared sensor, a bimetallic device, a thermometer, a change of state sensor, a semiconductor-based sensor (e.g., a silicon diode), or another type of temperature sensing device. A resistance temperature detector can have a resistor that changes resistance as the temperature changes. Circuitry can be used to evaluate the resistance of the resistor of the RTD to determine the temperature.

In some embodiments, the liquid lens 10 can include a heating element 38, which can be used to control the temperature in the liquid lens 10. In some embodiments, the heating element 38 can be embedded in the liquid lens 10. For example, the heating element 38 can be disposed between two layers of the liquid lens construction. A conductive lead can extend from the embedded location of the heating element 38 to a periphery of the liquid lens 10, such as for providing and/or receiving signals from the heating element 38. In some cases, the same conductive material can be used for both the temperature sensor 36 and the heater 38. The heating element 38 can comprise a resistive heater, a capacitive heater, an inductive heater, a convective heater, or another type of heater. The system can operate the heating element 38 based at least in part on signals received from the temperature sensor 36. The system can measure the temperature and use the heating element 38 to warm the liquid lens if the temperature is below a threshold value. The system can use feedback control to control the temperature using the temperature sensor 36 and the heating element 38.

In some embodiments, the liquid lens 10 and other electrowetting devices disclosed herein can be used in systems other than a camera system 200, such as an optical disc reader, an optical fiber input device, a device for reading output from an optical fiber, an optical system for biological measurement (e.g., inducing fluorescence in a biological sample), endoscopes, an optical coherence tomography (OCT) device, a telescope, a microscope, other types of scopes or magnifying devices, etc. Many of the principles and features discussed herein can relate to liquid lenses 10 and/or electrowetting devices used in various contexts. A liquid lens system can include a liquid lens 10 and a controller 206 for controlling the liquid lens 10. An electrowetting system can include an electrowetting device and a controller 206 for controlling the electrowetting device. In some embodiments, various camera elements, such as the imaging sensor 202, autofocus system 222, orientation sensor 220, and/or other optical elements 204 can be omitted. In some implementations, the liquid lens 10 can be omitted. The optical elements 204 can include any suitable electrowetting device, or movable optical element, or active lens system disclosed herein, such as to implement auto focus, zoom, OIS, off-axis focus, or any combination thereof.

### Capacitance Control and Temperature

When a voltage is applied, the liquid lens 10 can effectively form a capacitor. For example, at least the first electrode 22 and the first fluid 14 can form an effective capacitor (e.g., similar to a parallel plate capacitor, where the first fluid 14 operates as one of the parallel plates and the electrode 22 operates as the other parallel plate). The capacitance can increase as the first fluid 14 covers more area of the side wall (e.g., effectively forming a larger parallel plate). In some cases, capacitance can also increase as the surface area of the fluid interface 15 increases. The position of the fluid interface 15 on the side wall can be determined from a measurement that is indicative of the capacitance between the first electrode 22 and the first fluid 14. The voltage applied between the electrodes 22 and 26 can be determined or adjusted based on the measurement that is indicative of the capacitance, in order to position the fluid interface 15 at a location (e.g., a location configured to provide a focal length specified by a camera system). For example, a camera system can provide a command to set the liquid lens 10 at a particular focal length, and a voltage can be applied to the liquid lens 10. A measurement can be taken that is indicative of the capacitance between at least the first electrode 22 and the first fluid 14 (e.g., a measurement of the capacitance between at least the first electrode 22 and the second electrode 26 in electrical communication with the first fluid 14). If the measurement indicates that the capacitance is below a value that corresponds to the particular focal length the system can increase the voltage applied. If the measurement indicates that the capacitance is above the value that corresponds to the particular focal length, the system can decrease the voltage applied. The system can make repeated measurements and adjustments to the voltage to hold the fluid interface 15 at the position that provides the particular focal length and/or to adjust the fluid interface 15 to a different position that provides a different focal length.

In some embodiments, the capacitance (e.g., between at least the electrode 22 and the first fluid 14) that results from a single fluid interface 15 position can vary with different temperatures. Accordingly, when holding a constant voltage or when applying voltages to hold a constant capacitance, the focal power of the liquid lens 10 can drift, for example, as the temperature of the liquid lens 10 changes. Without being limited by theory, it is believed that a dielectric constant or permittivity of the insulating material 24 (e.g., parylene) can change as the temperature changes, which can affect the capacitance.

Changes in temperature can also affect the optical power of the liquid lens 10 through flexure or movement of one or both of the windows 18 and 20. Various embodiments are discussed herein in connection with flexing of the front window 20, although it will be understood that either or both of the windows 18 and 20 can flex or move, which can affect the optics of the liquid lens 10. For example, as the temperature increases, the front window 20 can flex outwardly (e.g., as shown in FIG. 2). The flexed window 20 can produce optical power, for example, as a convex side of a lens. As the temperature increases, the optical power from flexing of the window 20 can increase, and the same optical power of the overall liquid lens can be achieved with less curvature of the interface 15 (e.g., for a positive diopter target). The liquid lens 10 can have a window component of the optical power, and a fluid interface component of the optical, which can combine to provide the optical power of the liquid lens. In some embodiments, the liquid lens 10 can have a variable volume component that does not affect the optical power, and the features relating to optical power from flexing of the window can be omitted.

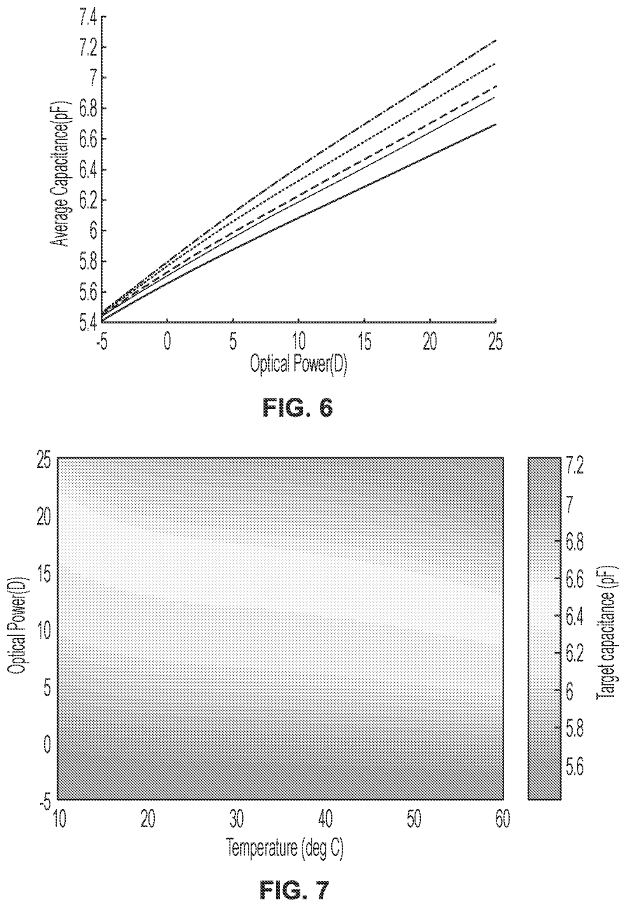

FIG. 6 is a plot showing how the relationship between the optical power and capacitance is affected by temperature. The different lines in FIG. 6 represent different temperatures. From the bottom to the top, the lines represent 10 degrees C., 20 degrees, C, 30 degrees C., 50 degrees C., and 60 degrees C. As can be seen in FIG. 6, the different temperatures can produce different relationships between the optical power and the capacitance. For example, when at 10 degrees C., about 20 diopters of optical power can be produced by driving the fluid interface 15 to a position that produces a capacitance of about 6.5 pF when at 10 degrees C. However, when at 60 degrees C., that same 20 diopters of optical power would result from driving the fluid interface 15 to a position that produces about 7 pF. The 6.5 pF of capacitance at 60 degrees C. would only result in about 11 diopters of optical power, instead of the about 20 diopters of optical power at 10 degrees C. FIG. 7 is a plot that shows target capacitance values that can be used to produce various optical powers between −5 and 25 diopters while at various temperatures between 10 degrees C. and 60 degrees C. By way of example, the same target capacitance of about 6 pF can produce about 3 diopters at 60 degrees C. and about 8 diopters at about 10 degrees C.

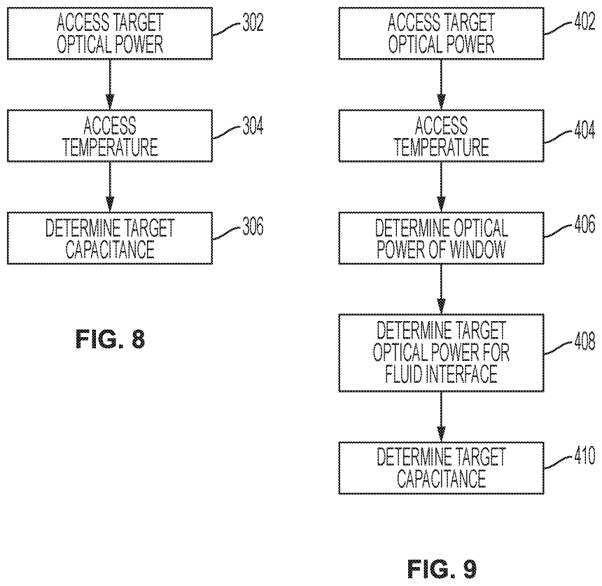

The system can control the liquid lens based on capacitance, such as using capacitance feedback or closed-loop control. The target capacitance (e.g., capacitance set point for feedback control) can be based at least in part on the target optical power for the liquid lens and the temperature. FIG. 8 is a flowchart of an example embodiment of a method for controlling a liquid lens 10. At block 302, the controller can access a target optical power for the liquid lens 10. The target optical power can be received from an autofocus system, or other component of a camera, or from user input, etc. In some cases, the controller can determine the target optical power for the liquid lens 10. At block 304, the controller can access temperature information for the liquid lens 10. The temperature can be received from a temperature sensor in the liquid lens 10, as discussed herein. A temperature sensor outside the liquid lens 10, such as part of the camera or integrated device, can be used to approximate the temperature of the liquid lens 10. In some embodiments, the temperature of the liquid lens can be inferred from other information. For example, various embodiments discussed herein relate to determining the temperature of the liquid lens 10 based at least in part on the voltage(s) applied and the resulting capacitance(s) that result. At block 306, the system can determine the target capacitance based at least in part on both the target optical power and the temperature. For example, a lookup table can be stored in memory and can have target capacitance values that correspond to various combinations of optical power and temperature. For example, a 2D lookup table can be similar to FIG. 7. In some embodiments, a formula, equation, or algorithm can be applied to determine the target capacitance. The target capacitance value can be used to drive the liquid lens 10 to produce the target optical power, such as by using feedback or closed-loop control.

FIG. 9 is a flowchart of an example embodiment of a method for controlling a liquid lens 10. At blocks 402 and 404 the target optical power and the temperature can be accessed, similar to FIG. 8. At block 406, the optical power of the window can be determined based at least in part on the temperature. For example, a higher temperature can result in more bowing of the window and more optical power or focusing can be applied to light that passes through the window. A lookup table or a formula, equation, or algorithm can be used to determine the optical power of the window. Different sizes and configurations of windows can yield different optical powers as the temperature changes. At block 408, the target optical power for the fluid interface can be determined, based at least in part on the target optical power for the overall liquid lens 10 (e.g., received at block 402) and the optical power of the window (e.g., determined at block 406). For example, the determined optical power of the window can be subtracted from the total liquid lens target optical power to determine the target optical power for the fluid interface 15. If the window 20 of a liquid lens 10 bows to produce 2 diopters of optical power at a certain temperature, then a target optical power for the fluid interface 15 can be 8 diopters in order to achieve a target optical power for the overall liquid lens of 10 diopters. At block 410, a target capacitance can be determined using at least the target optical power for the fluid interface 15.

In some embodiments, the method of FIG. 8 can account for window flexure without determining the specific window and fluid interface components of the optical power. For example, the lookup table or the formula, equation, or algorithm used in FIG. 8 can be configured to account for the optical power caused by flexing of the window across the range of temperatures. For example, two different 2D lookup tables similar to FIG. 7 can have different values depending on whether the optical power on the Y-axis is the fluid interface component of the optical power, or the total optical power including both the fluid interface and flexed window components. The lookup table or the formula, equation, or algorithm can also account for other changes to the liquid lens 10 caused by changes in temperature, such as changes in the index of refraction of the materials. For example, as the difference between the indices of refraction of the fluids 14 and 16 changes with the temperature, different amounts of fluid interface curvature (e.g., and corresponding capacitance) can be used to produce a target optical power. The lookup tables and the formula, equations, or algorithms discussed herein can be populated or determined empirically, through testing of actual liquid lenses and associated systems, or through modeling, for example.

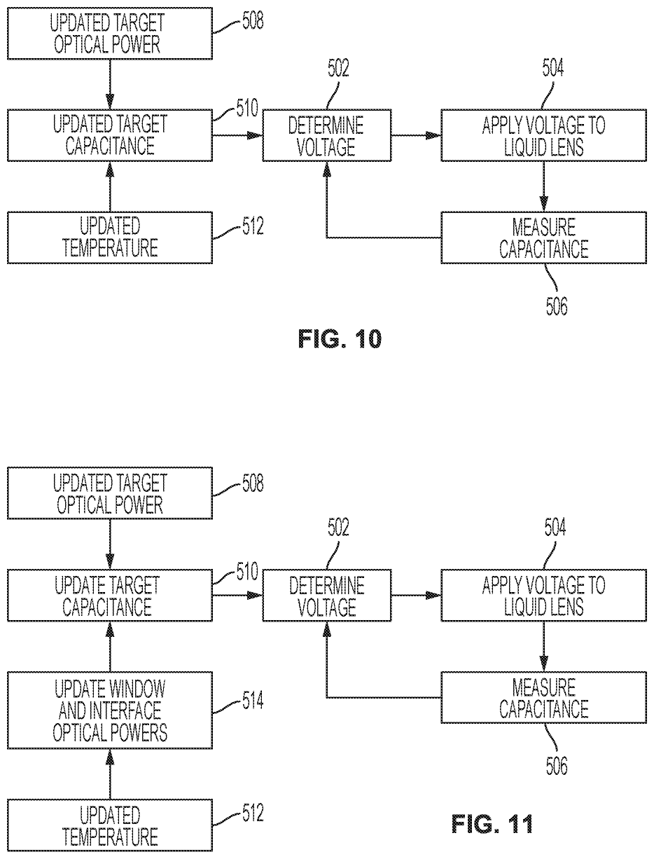

FIG. 10 is a flowchart of an example embodiment of a method for controlling a liquid lens 10. At block 502, the system (e.g., the controller 206) can determine a voltage to be applied to the liquid lens 10. The voltage can be based at least in part on the target capacitance, which can be determined using any suitable method or technique disclosed herein. At block 504, the voltage is applied to the liquid lens 10. One or more voltages can be applied to any combination of the electrodes 22 and 26 to produce a voltage differential, which can drive the fluid interface 15, as discussed herein. Driving the fluid interface 15 can produce a capacitance, as discussed herein. The capacitance can be formed between at least the first fluid 14 and the insulated electrode 22. At block 506 the capacitance of the liquid lens 10 can be measured. In some embodiments, the capacitance can be measured directly (e.g., by a capacitance sensor incorporated into the liquid lens). In some embodiments, the capacitance can be measured indirectly or can be inferred from other information. For example, the system can have at least one current mirror, charge sensor, etc., which can be used to produce information that is indicative of the capacitance. In some embodiments, a voltage can be produced that is indicative of the capacitance of the liquid lens 10. Additional details and techniques for determining the capacitance of the liquid lens 10, as well as further details regarding feedback control are disclosed in PCT Patent Application Publication No. WO 2018/187587, published on Oct. 11, 2018, and titled LIQUID LENS CONTROL SYSTEMS AND METHODS, the entirety of which is hereby incorporated by reference.

The method can return to block 502, where the system can determine one or more new voltage values to be applied to the liquid lens 10, using the measured capacitance. For example, if the measured capacitance is less than the target capacitance, the voltage can be increased. If the measured capacitance is more than the target capacitance, the voltage can be decreased. Various types of control techniques can be used. For example, a PID controller, a PI controller, or any other suitable controller type can be used to implement feedback control based on the capacitance.

At block 508, an updated target optical power can be received or determined. For example, an autofocus system of the camera can request a different focal length, or a user can provide input that dictates a different optical power. At block 510, the system can update the target capacitance 510 in view of the updated target optical power. For example, a new target capacitance value can be obtained from a lookup table or from a formula, equation, or algorithm. At block 512, updated temperature information 512 can be received or determined. For example, a temperature sensor can provide updated temperature information, which can indicate a change in the temperature of the liquid lens 10. At block 510, the target capacitance can be updated, as discussed herein. In some cases, updating the target capacitance at block 510 can account for both an updated target optical power and an updated temperature. For example, both input values for a 2D lookup table can change.

FIG. 11 is a flowchart of an example embodiment of a method for controlling a liquid lens 10. The method of FIG. 11 can be similar to the method of FIG. 10, except that FIG. 11 includes block 514. At block 514, the window component and the fluid interface component of the target optical power can be updated using at least the updated temperature information. For example, the new optical power of the window can be determined using the updated temperature information, and the new optical power of the window can be subtracted from the overall target optical power to calculate the new fluid interface component of the target optical power.

In some embodiments, the temperature can be determined using a temperature sensor in the liquid lens 10. In some embodiments, the temperature can be determined based on other information, as discussed herein. Accordingly, in some embodiments, the temperature sensor can be omitted from the liquid lens. Omitting the temperature sensor can reduce the size and cost of the liquid lens. In some cases, a temperature sensor can degrade over time, which can impede accurate temperature measurements. In some cases, a temperature sensor can be subject to corrosion, which could compromise the liquid lens. Accordingly, it can be advantageous, in some embodiments, to determine the temperature indirectly, without a temperature sensor. In some cases, the indirect determination of the temperature can be used for double checking or calibrating a temperature sensor of the liquid lens 10.

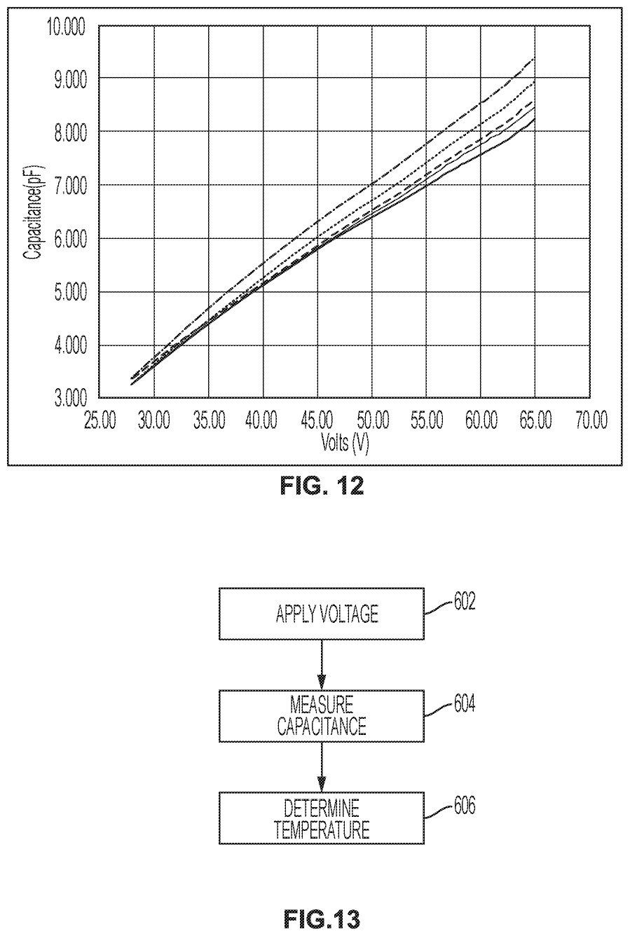

FIG. 12 is an example plot showing how the relationship between applied voltage and resulting capacitance can vary with changes in temperature. From the bottom to the top, the lines of FIG. 12 represent 10 degrees C., 20 degrees, C, 30 degrees C., 50 degrees C., and 60 degrees C. As the temperature decreases, it can take more voltage to produce an amount of capacitance in the liquid lens, for example. Similarly, a given voltage value can produce more capacitance as the temperature increases. The capacitance and voltage values can be used to indirectly determine the temperature, as discussed herein.

FIG. 13 is a flowchart of an example embodiment for determining a temperature of a liquid lens 10. At block 602, a voltage can be applied to the liquid lens 10. The voltage can drive the fluid interface 15 as discussed herein. The resulting capacitance can be measured at block 604 (e.g., directly or indirectly). At block 606, the temperature can be determined based at least in part on the applied voltage and the resulting capacitance. By way of example, and with reference to FIG. 12, a voltage of 60 volts can be applied to the liquid lens 10. A measured capacitance of 7.6 pF at 60 volts can result in a determined temperature of about 10 degrees C. Whereas, a measured capacitance of 8.1 pF at 60 volts can result in a determined temperature of about 50 degrees C. And a measured capacitance of 8.6 pF at 60 volts can result in a determined temperature of about 10 degrees C. A lookup table or a formula, equation, or algorithm can be used to determine the temperature.

As can be seen in FIG. 12, the difference in capacitance values that result from different temperatures can increase as more voltage is applied. For example, at 40 volts, there is a difference of about 0.5 pF between the capacitance values corresponding to 10 degrees C. and 60 degrees C., whereas at 60 volts, there is a difference of about 1.2 pF between the capacitance values corresponding to 10 degrees C. and 60 degrees C. Accordingly, improved sensitivity can result from applying a relatively high voltage when determining the temperature. In some embodiments, the system can have a temperature measurement voltage (e.g., stored in memory), and the system can use that temperature measurement voltage when indirectly determining the temperature, even if that voltage corresponds to a different fluid interface position than dictated by the camera system. For example, a first voltage can be applied to the liquid lens 10 to drive the fluid interface to a position to try to provide a target optical power. A second (e.g., higher) voltage can be applied to determine the temperature. Then a third voltage can be applied to try to provide the target optical power while accounting for the determined temperature. The third voltage can be different from the first voltage by some degree that is configured to account for the effect of the temperature.

In some embodiments, the same voltage can be applied each time the temperature is to be determined, regardless of the target optical power. This can result in improved sensitivity in the temperature determination, in some cases. This can also permit the use of a smaller lookup table or a simpler formula, equation, or algorithm for determining the temperature, which can save memory. In some cases, a minimum voltage threshold can be applied for measuring the temperature. For example, when the temperature is going to be determined, if the voltage being applied is below the threshold (e.g., below 50 volts), then the voltage can be raised to the threshold value (e.g., 50 volts) for the temperature determination. However, if the voltage is over the threshold, then the diving voltage value can be used for making the temperature determination. In some embodiments, the voltage for determining the temperature can be outside (e.g., above) the operational range of the liquid lens 10. For example, for optical quality reasons, the liquid lens 10 system might not be operable to drive the liquid lens 10 above a certain voltage value. However, the temperature test voltage can be above that certain voltage value. The liquid lens 10 can be configured to move the fluid interface 15 fast enough that the fluid interface can quickly jump to the position associated with the temperature test voltage, and then quickly return back to the position of the driving voltage (or updated driving voltage) fast enough that the fluid interface can be at the driven position and sufficiently settled to produce an image at the appropriate time. For example, when recording video images at 30 or 60 frames-per-second, the fluid interface can quickly jump to the position driven by the temperature test voltage and back again between image frame captures.

In some embodiments, the voltage and resulting capacitance that result from driving the liquid lens 10 can be used to determine the temperature. For example, a lookup table can include temperature values across various voltage and capacitance values. This approach can enable faster temperature measurements, since the fluid interface does not need to move off of the currently driven position to determine the temperature. This approach can also result in improved optical quality because of fewer ripples or other disturbances in the fluid interface, which can result from jumping back and forth to a temperature measurement voltage (e.g., within a single frame of 60 frames per second, or 120 frames per second, or 180 frames per second or any values or ranges therebetween).

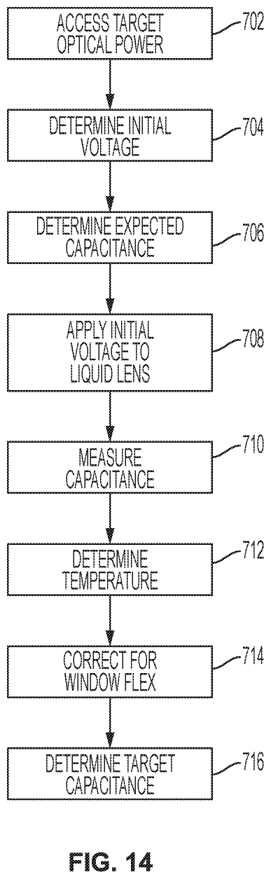

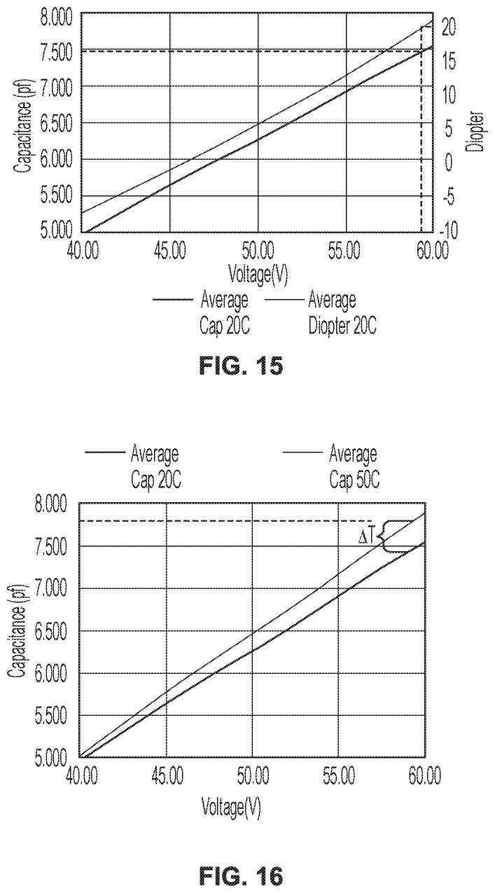

FIG. 14 is a flowchart of an example embodiment of a method for determining a target capacitance for controlling a liquid lens 10. At block 702 the system can access a target optical power, which can be received from an autofocus system of the camera, for example. At block 704 an initial or reference voltage can be determined, and at block 706 an expected or reference capacitance can be determined. For example, a lookup table or a formula, equation, or algorithm can be used to determine the initial or reference voltage and the expected or reference capacitance. In some cases, the initial or reference voltage and the expected or reference capacitance can be based on the target optical power and can be independent of temperature (which may not be determined yet at this stage). The voltage and capacitance associated with the target optical power for a default temperature (e.g., 20 degrees C.) can be used. With reference to FIG. 15, if the target optical power is 20 diopters, the initial or reference voltage can be 59.5 volts, and the expected or reference capacitance can be 7.48 pF. In some cases, the same default temperature (e.g., 20 degrees C.) can be used each time to determine the initial or reference voltage and the expected or reference capacitance. However, in some cases, a last known liquid lens temperature, or an estimated temperature, or a temperature measurement from outside the liquid lens can be used to determine the reference voltage and/or the reference capacitance.

At block 708 the system can apply the initial or reference voltage to the liquid lens, and at block 710 the actual resulting capacitance can be measured. At block 712 the liquid lens temperature can be determined. For example, the difference between the expected or reference capacitance and the actual measured capacitance can be indicative of the difference between the reference temperature (e.g., 20 degrees C.) and the actual liquid lens temperature. For example, with reference to FIG. 16, if the measured capacitance were 7.78 pF that can correspond to a temperature of 50 degrees C. The difference of +0.3 pF between the measured capacitance and the reference capacitance at 59.5 volts can correspond to a difference of +30 degrees C. between the actual liquid lens temperature and the initial or reference temperature of 20 degrees C. A lookup table or a formula, equation, or algorithm can be used to determine the temperature.

In some embodiments, at block 714, the system can correct for window flexure based on the determined temperature. For example, a corrected target optical power for the fluid interface can be determined that accounts for the optical power caused by bowing of the window, as discussed herein. For example, if the flexed window at 50 degrees C. produces 3 diopters of optical power, the target optical power for the fluid interface 15 can be 17 diopters, which can yield 20 diopters for the total optical power of the liquid lens.

At block 716, the system can determine the target capacitance. The target capacitance can be different than the initial expected or reference capacitance in Block 706, because the determined capacitance of block 716 can account for the effects of temperature on the capacitance (e.g., changes in the permittivity of the insulating material), and because the determined capacitance of block 716 can account for the flexing or movement of the window. A lookup table or a formula, equation, or algorithm can be used to determine the target capacitance based at least in part on the determined temperature, as discussed herein. In some embodiments, the same multi-dimensional lookup table can be used for determining the initial voltage, the expected capacitance, the determined temperature, and/or the determined target capacitance.

In some cases, block 706 can be omitted, and the expected capacitance would not be required. For example, the initial voltage (e.g., 59.5 volts) can be determined based on the initial target optical power (e.g., 20 diopters). That initial voltage can be applied and the resulting capacitance can be measured. The temperature can be determined at block 712 using the applied initial voltage and the resulting capacitance, even without knowing the expected capacitance. In some embodiments, block 714 can be omitted. In some liquid lens designs, the window optical power does not change with temperature. For example, a different variable volume area can be used that does not affect the optical power. In some cases, the correction for the window flexure can be built into block 716. For example, the lookup table for determining the target capacitance based on the temperature can account for the difference in the target fluid interface optical power that results from the flexed window at the temperature. For example, using block 714 the target fluid interface optical power can be changed from 20 diopters to 17 diopters (to account for the 3 diopters of window flexure), and the lookup table can indicate that 17 diopters (of fluid interface optical power) at 50 degrees corresponds to a target capacitance of 7.6 pF. Alternatively, the lookup table for determining the target capacitance can indicate that 20 diopters (of total liquid lens optical power) at 50 degrees corresponds to a target capacitance of 7.6 pF.

The target capacitance can be used to control the liquid lens 10. In some cases, the target capacitance can be used for feedback or closed-loop control of the liquid lens. For example, the controller 206 can monitor the capacitance and vary the voltage to reach the target capacitance. Similar to FIGS. 10 and 11, when a different target optical power is received or determined (e.g., from the autofocus system), the target capacitance can be updated. When a different temperature is determined (e.g., based on the applied voltage and resulting capacitance) the target capacitance can be updated and/or the target optical power for the interface 15 can be updated (which can also affect the target capacitance), similar to FIGS. 10 and 11. Instead of receiving temperature information from a temperature sensor, the temperature can be determined (e.g., periodically) as the control system loops, as discussed herein. In some cases, the system can perform the method of FIG. 14 each time the temperature information is to be updated. In some embodiments, the method of FIG. 14 can be a startup block, which can be performed when the system initiates. The method of FIG. 14 can start when the system has no temperature information. In some cases, the system can perform the method of FIG. 14 each time a new target optical power is received or determined. In some cases, the method of FIG. 14 can be a feed-forward control process. The system can perform both feed-forward control and feed-back control. For example, the system can perform a feed-forward control operation such as the method of FIG. 14, and the system can then transition to a feed-back control approach. In some embodiments, block 716 can determine target voltage rather than target capacitance. For example, the determined temperature of 50 degrees C. can result in a target voltage of 58 volts instead of the reference 59.5 volts (which has used a temperature of 20 degrees C.). The target voltage (e.g., 58 volts) can be delivered to the liquid lens 10.

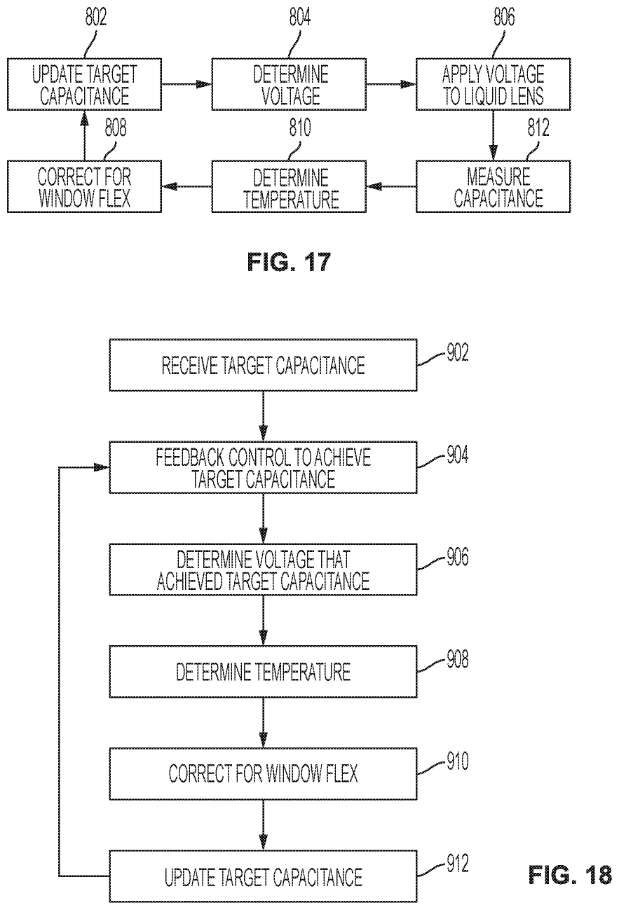

FIG. 17 is a flowchart of an example embodiment of a method for controlling a liquid lens 10. The method of FIG. 17 can used closed-loop or feedback control based on the capacitance. The method can use a target capacitance, which can initially be received from the method of FIG. 14, or any other suitable source. At block 802, the target capacitance can be updated (e.g., the initial target capacitance received). At block 804 a voltage can be determined based at least on the target capacitance. For example, a PID controller or any other type of controller or control approach can be used to determine the voltages. For example, in some cases the voltage can be overdriven or input shaped, etc. At block 806 the voltage is applied to the liquid lens 10. At block 812, the capacitance can be measured (e.g., directly or indirectly, as discussed herein). At block 810, the temperature can be determined based on the applied voltage and the resulting capacitance, as described herein. For example, a lookup table can be used, or a formula, equation, or algorithm can be used. At block 808, a correction can be made for the flexing of the window based at least in part on the determined temperature, as discussed herein. For example, the target optical power for the fluid interface and/or the target capacitance can be updated to account for the optical power produced by the curvature of the window at the determined temperature. At block 802, the target capacitance can be updated. The target capacitance can be updated based on the determined temperature, such as to account for changes in the properties of the materials in the liquid lens (e.g., changes in permittivity of the insulating material, changes in the thermal expansion of the fluids, and/or changes in the indices of refraction of the fluids). The method of FIG. 17 can then repeat and continue looping to control the liquid lens 10. As the temperature of the liquid lens changes, the feedback loop can determine the updated temperatures and adjust the target capacitance and/or voltage values accordingly. In some embodiments, block 808 can be omitted or can be combined with block 802, as discussed herein.

In some embodiments, the block 810 for determining the temperature can be performed during each iteration of the control loop. In some embodiments, the block 810 for determining the temperature can omitted during some iterations of the control loop. For example, in some iterations the method of FIG. 17 can go from block 812 to block 804, without determining the temperature and without updating the target capacitance or correcting for changes in window flexure. The temperature can be determined periodically (e.g., at regular time intervals), or intermittently. In some cases, a set number of non-temperature iterations can be performed between instances of the full temperature iteration of FIG. 17. For example, the temperature update can be performed every second, every fifth, every tenth, iteration or at any other suitable interval or frequency.

FIG. 18 is a flowchart of an example embodiment of a method for controlling a liquid lens 10. At block 902, the target capacitance can be received or determined (e.g., from the method of FIG. 14). At block 904, the system can perform feedback control to achieve the target capacitance. In some cases, closed-loop or feedback control can be used, as discussed herein. In some cases, multiple iterations or loops through the control process may be performed before the target capacitance is obtained. Once the target capacitance has been achieved, the voltage that produced the target capacitance can be determined at block 906. Then the temperature can be determined at block 908 based at least in part on the target capacitance and the voltage that was used to obtain the target capacitance. For example, a lookup table or a formula, equation, or algorithm can be used, as discussed herein. At block 910, a correction for flexing of the window can be made. For example, the target optical power for the fluid interface 15 can be changed based on the temperature to compensate for the curvature of the window. At block 912 the target capacitance can be updated. The target capacitance can be changed to account for the changed target optical power that was determined at block 910. The capacitance can be changed based on the determined temperature to account for the effect of temperature on the capacitance itself (e.g., due to change of the permittivity of the insulating material). As discussed herein, block 910 can be omitted or can be combined with block 912. The method can return to block 904 and the feedback control system can be used to achieve the updated target capacitance, and the method can repeat.

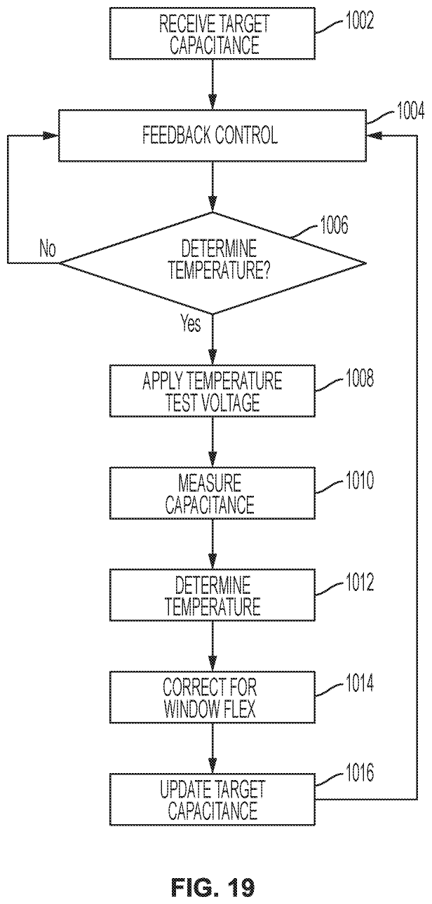

FIG. 19 is a flowchart of an example embodiment of a method for controlling a liquid lens 10. At block 1002 a target capacitance can be received or determined, such as using the method of FIG. 14. At block 1004 the system can perform feedback control, such as to achieve or hold the target capacitance. During the feedback control the system can determine whether a temperature is to be determined at block 1006. Various conditions can be used to determine whether a temperature is to be determined. For example, in some cases the temperature can be determined periodically (e.g., at regular time intervals). If a threshold amount of time has passed since the previous temperature update, then system can proceed to determine the temperature. In some cases, the system can wait until the target capacitance is achieved before determining the temperature. In some embodiments, the temperature determinations can be coordinated with the actions of the camera, such as between frame captures of a video recording. In some embodiments, the temperature determinations can be coordinated with the tilt or orientation of the fluid interface. For example, during optical image stabilization (OIS), the fluid interface can tilt back and forth. The temperature determinations can be performed when the fluid interface is at the untilted position, or under a threshold amount of tilt.

The temperature can be determined using any suitable approach disclosed herein. FIG. 19 shows an example where the temperature is determined using a set temperature test voltage, which may be different than the driving voltage. At block 1008, the temperature test voltage can be applied to the liquid lens 10. The temperature test voltage can be different from the driving voltage. As discussed herein, the temperature test voltage can be a relatively high voltage, which can result in more sensitivity for the temperature determination. Also, applying a specific temperature test voltage can enable temperature measurements to be determined regardless of the tilt (e.g., dictated by the OIS system), which can yield more flexibility for the times that temperatures can be determined. For example, as the fluid interface is tilting (e.g., for OIS), the temperature test voltage can be applied (e.g., to all the insulating electrodes), which can untilt the fluid interface for the temperature measurement. After the temperature measurement, the fluid interface can return the tilted configuration.

At block 1010, the capacitance can be measured. At block 1012 the temperature can be determined from at least the applied temperature test voltage and the resulting capacitance, as described herein. At block 1014, a correction can be made to account for the flexing of the window, as discussed herein. At block 1016, the target capacitance can be updated, to account for the determined temperature and/or the corrected interface curvature that accounts for the window flexure. Block 1014 can be omitted or combined with block 1016, as discussed herein. The method can return to block 1004 where feedback control can be used to implement the updated target capacitance, and the method can repeat. In some embodiments, the temperature can be determined using the driving voltage and the target capacitance, instead of jumping to a specific temperature test voltage and/or interface position.

Although not shown in FIGS. 17-19, an updated target optical power can result in a new target capacitance, such as based on changes to the target optical power for the liquid lens. Also, FIG. 17-19 could start with the initially expected capacitance of block 706 and/or the initial voltage of block 704 of FIG. 14. The feed-forward process can be omitted, in some cases. The closed-loop feedback control can start before the temperature has been determined. For example, the initial target capacitance can be determined independent of the temperature, or assuming a default temperature. The temperature can be determined as part of the feed-back control process and after at least one iteration, the system can be corrected for the determined temperature.

Tilting of the liquid lens (e.g., for OIS) can be performed and controlled along with the control of the optical power and temperature determinations disclosed herein. For example, different target capacitances can be determined for the different insulated or driving electrodes 22a-d. Although some embodiments, are disclosed in connection with four quadrant electrodes 22a-d, any suitable number of electrodes 22 can be used (e.g., 6, 8, 10, 12, 16, 24, 32 electrodes, or more). One or more lookup tables or formulas, equations, or algorithms can be used to determine the target capacitance values to generate the prescribed tilt. In some cases, the system can determine capacitance offsets from the base target capacitance. A base target capacitance can be determined to generate the optical power requested for the liquid lens. A positive capacitance offset for one of the electrodes can cause the fluid interface to be driven further downward at that electrode, and a negative capacitance offset for another of the electrodes can cause the fluid interface to be driven further upward at that electrode. The target capacitance offsets can be determined based on the amount of tilt (e.g., physical or optical tilt angle) and on the tilt direction (azimuthal angle). In some embodiments, the capacitance offsets for tilt can depend, at least in part, on the determined temperature. For example, the same capacitance offset can cause the fluid interface to move to a different position at 10 degrees C. than at 50 degrees C., as discussed herein.

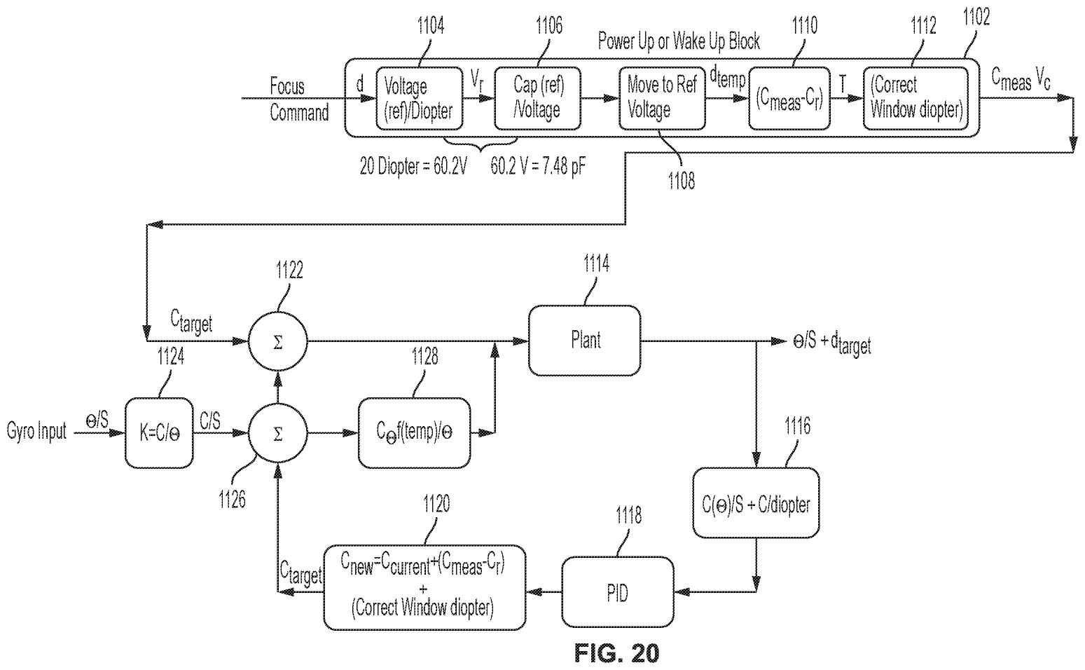

FIG. 20 is a block diagram of an example approach for controlling a liquid lens for optical power and tilt. An initiation block 1102 can be performed, in some cases, which can determine a starting target capacitance. The initiation block can be performed upon power up or wake up of the camera, or when the process otherwise starts, or when a new focus or optical power target is received. The initiation block 1102 can have features similar to the method of FIG. 14. At block 1104, a reference voltage is determined from the target optical power. At block 1106, a reference capacitance can be determined from the reference voltage. For example, a target optical power of 20 diopters can result in a reference voltage of 60.2 volts and a reference capacitance of 7.48 pF. At block 1108 the reference voltage is applied to the liquid lens 10, and the fluid interface moves to a location driven by the reference voltage. The same reference voltage can be applied to each of the insulated or driving electrodes 22a-d. At block 1110, the capacitance can be measured (e.g., directly or indirectly). A difference between the reference capacitance and the measured capacitance that resulted from the reference voltage can be determined. The temperature can be determined at block 1110, similar to other embodiments discussed herein. At block 1112, the system can correct for window curvature based on the determined temperature. The block 1102 can output a target capacitance value (which can be corrected to account for the temperature) and/or a voltage value associated with that target capacitance value. As discussed herein, the correction for window flexure can be omitted or combined with the capacitance temperature correction. In some cases, block 1106 can be omitted, and the temperature can be determined using the reference voltage and the resulting capacitance, without determining a reference capacitance. In some embodiments, the temperature is not directly determined, but the target capacitance can be determined (e.g., using the reference voltage and resulting capacitance or using the difference between the measured capacitance and the reference capacitance) to compensate for the effects of temperature. In various other embodiments disclosed herein, the intermediate step of making the actual temperature determination can be omitted. In some cases, the delta capacitance, the capacitance resulting from the applied voltage, or the voltage that achieves the target capacitance can be representative of the temperature, even without determining the actual temperature value in degrees.

Voltage can be applied to the plant (e.g., the liquid lens 10) at block 1114. The resulting capacitance can be measured at block 1116. A PID controller 1118 (or any other suitable type of controller) can implement feedback control based on the measured and target capacitance values. A new target capacitance value can be determined at block 1120. The new target capacitance value can be based at least in part on the applied voltage and the resulting capacitance, and the new target capacitance can compensate for the temperature of the liquid lens. For example, a new target capacitance value can be determined based on one or more of the previous target capacitance value, the difference between the target capacitance and the measured capacitance, the corrected target optical power that accounts for curvature of the window. In some cases, a capacitance correction can be a determined and can be combined (e.g., at block 1122) with the previous target capacitance. The feedback process can continue with new voltages being applied to the plant (e.g., liquid lens 10). In some embodiments, the controller 1118 can determine new voltage values to implement the updated target capacitance. For example, block 1118 can be after block 1120 or after block 1122.

In some cases, input can be received from a gyroscope or other position or orientation sensor. For example, an angular velocity can be received, which can include both direction and magnitude information. At block 1124, capacitance offset values can be determined for the electrodes 22a-d based on the input from the gyroscope. The capacitance offset values can be configured to tilt the fluid interface to perform optical image stabilization (OIS). At block 1126, the capacitance offset values can be combined with the base target capacitance (e.g., for implementing a target optical power), to obtain target capacitance values for the individual electrodes 22a-d. At block 1128, the capacitance offset values can be determined or corrected based on the temperature of the liquid lens. Accordingly, the control system can cause the liquid lens to implement a target optical power (e.g., for autofocus) and a target tilt (e.g., for OIS) that are corrected to account for temperature changes in the liquid lens 10.

When the liquid lens interface 15 is tilted, different voltages can be applied to different electrodes 22a-d and different capacitance values can be measured for the different electrodes 22a-d. In some embodiments, the capacitances for the electrodes 22a-d can be averaged and the applied voltages for the electrodes 22a-d can be averaged. The average capacitance and the average voltage can be used to determine the temperature of the liquid lens, similar to other embodiments disclosed herein. In some embodiments, the capacitance of a single electrode 22a or subset of the electrodes 22a-d can be used along with the voltage applied to that single electrode 22a or subset of the electrodes 22a-d to determine the temperature. In some cases, separate temperature values can be determined using the respective capacitance and voltage values for two or more of the separate electrodes 22a-d, and those separate temperature values can be averaged to determine the temperature of the liquid lens.

In some embodiments, the temperature can be determined by applying a test voltage (e.g., the reference voltage of block 1104) to one electrode 22a or a subset of the electrodes 22a-d, and measuring the resulting capacitance for that one electrode 22a or subset of the electrodes 22a-d. A more reliable and accurate temperature determination can result from applying a uniform test voltage across the full set of the electrodes 22a-d and measuring and averaging the capacitance for all of the electrodes 22a-d.

In some cases, tilting of the interface 15 of the liquid lens 10 can be implemented using voltage offsets rather than using different target capacitance values for the insulated or driving electrodes 22a-d. The voltage offsets can be layered on top of the focus control target capacitance. In some cases, the voltage offsets can be applied more quickly or directly to the liquid lens 10, as compared to capacitance offsets. Accordingly, using voltage offsets can be more efficient than using capacitance offsets for tilting the interface 15. The voltage offsets can be calculated based at least in part on the temperature of the liquid lens. The voltage offset calculations can include a temperature dependent gain that can be a function of one or more of temperature, voltage, and diopter.

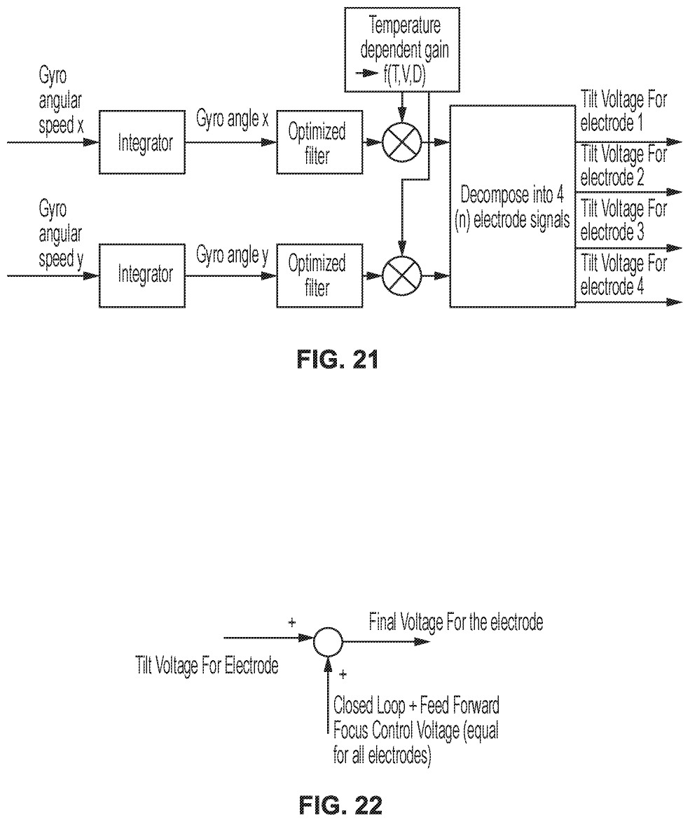

FIG. 21 is a block diagram disclosing an example embodiment for determining tilt voltage offsets for four electrodes 22a-d. The gyroscope can provide angular velocity in the X and Y directions. Integrators can be applied to determine the X and Y components of tilt angle. Optionally, one or more filters can be applied (e.g., optimized filters) which can shape the signals to compensate for the particular parameters of the liquid lens. A temperature dependent gain can be applied, which can depend on one or more of the temperature, voltage, and diopter. For example, different amounts of voltage offsets can be needed to obtain the same amount of tilt if the temperature changes, and if the lens is driven to a different optical power (e.g., due to the geometry of the cavity and/or the scaling of the relationship between optical power and voltage). The system can determine the individual voltage offsets for the four driving electrodes 22a-d. FIG. 22 shows the tilt voltages for the electrodes being combined with the focus control voltage values to produce the final voltage values for the driving electrodes 22a-d.

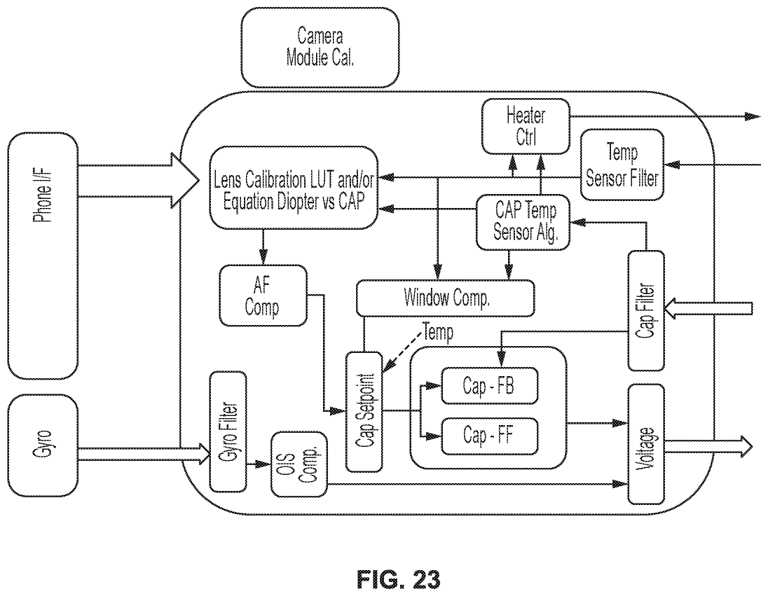

FIG. 23 is a block diagram of an example embodiment of a system for controlling a liquid lens. The phone or camera interface can provide target optical power information. The system can have a lookup table or equation for determining a target capacitance from the target optical power. A capacitance set point can be determined based on an autofocus component of the optical power and on the window component of the optical power. For example, as the temperature increases, the window can curve more, which can result in more optical power for the window component, which can result in less optical power needed for the autofocus component, which can result in a lower capacitance set point. The capacitance set point or target value can also depend on temperature, as discussed herein, because the permittivity of the insulating material can change with temperature. In some cases, the system can receive information from a temperature sensor. A temperature sensor filter can be applied. The measured temperature can be used to control an optional heater in some embodiments. The measured temperature can be used to determine the window component of the optical power (e.g., with a higher temperature resulting in more window curvature). The measured temperature can also be used to determine the capacitance from the target diopter. For example, as the temperature changes the permittivity of the insulating material and/or the indices of refraction of the fluids can change, which can change the relationship between the optical power and capacitance.

In some embodiments, the temperature sensor can be omitted. The heater can also be omitted, in some cases. The system can receive information indicative of the capacitance of the liquid lens 10 (e.g., formed by at least the first fluid 14 and the one or more electrodes 22). A filter can be applied to the capacitance information. The capacitance information can be used for feedback capacitance control. For example, the capacitance set point and the measured capacitance information can be compared, and the voltage values applied to the liquid lens can be adjusted accordingly. The capacitance information can also be used to determine the temperature of the liquid lens, as discussed herein. That determined temperature can be used to control a heater, to determine a window component of the optical power, and/or to determine the capacitance set point, as discussed herein.

The system can receive information from a gyroscope or other position or motion sensor. A filter can be applied to the gyroscope information. The system can determine OIS voltage values to tilt the interface 15 to implement OIS. Those voltage values can be combined with the voltage values for implementing the optical power. The combined voltages can be applied to the liquid lens to implement both OIS and autofocus. The system can use both capacitance based feedback and feed forward control.

The control systems and approaches disclosed herein can result in low hysteresis. For example, as the target capacitance is swept up through a range of operation, the optical power can increase. As the target capacitance is swept down through the range of operation, the optical power can decrease. In some instances, a particular target capacitance value can yield a slightly different optical power during the up sweep as compared to the optical power provided by that same target capacitance on the down sweep. That hysteresis difference in optical power can be less than or equal to about 1 diopter, about 0.75 diopter, about 0.5 diopter, about 0.4 diopter, about 0.3 diopter, about 0.25 diopters, about 0.2 diopter, about 0.15 diopter, about 0.1 diopter, about 0.075 diopter, about 0.05 diopter, about 0.025 diopters, about 0.02 diopters, about 0.01 diopters, or less, or any values or ranges therebetween.

### Temperature and Polar Fluid Resistance

The resistance of the polar fluid can change with temperature. In some embodiments, the polar fluid resistance can be determined from the rate at which charge builds up in the liquid lens. The liquid lens can have a sensor that can provide information indicative of the charge current. For example, a current mirror can be used. The sensor (e.g., which can include a current mirror) can also be used for determining the capacitance of the liquid lens. The sensor can be used to determine the charge at a first time and at a second time, and can determine the rate at which charge is building up (e.g., in at least the first fluid 14). That charge rate can be indicative of the resistance of the first fluid 14, which can be indicative of the temperature.

The system can determine the lens temperature using circuitry which can also be used to measure capacitance. One capacitance sensing approach can integrate charge current over sufficient time to determine the capacitance. For example, the circuit or system can initiate charge and start integration. After a time (e.g., which can be a few microseconds), integration can be stopped. By reading the integrator output, the capacitance can be determined. The lens can be represented as an RC circuit, and charge current over time can be:

$$\text{?} ( t ) = \begin{matrix}U \\ R\end{matrix} \text{?} \\ \text{?} \text{indicates text missing or illegible when filed}$$

Where U is the voltage that we charge to, R is lens resistance, and C is lens capacitance. The term time constant τ=RC can determine the speed of charge. By integrating charge current over sufficient time (e.g., equal to 5τ), enough of the total charge (e.g., 99% of total charge although other values may also be sufficient) can be captured that the integration can sufficiently approximate an integration from 0 to ∞.

$${\int }_{0}^{∞} \frac{V}{R} \text{?} dt = VC = m 1 ( This can be referred to as measurement 1 ) \\ \text{?} \text{indicates text missing or illegible when filed}$$

Total charge does not depend on R. So ml can be used to determine C.

$$C = \frac{m 1}{V}$$

By integrating over a shorter time T (e.g., on the order of one time constant), the integrated value can depend on both R and C.

$${\int }_{0}^{T} \frac{V}{R} \text{?} dt = UC ( 1 - \text{?} ) = m 2 ( This can be referred to as measurement 2 ) \\ \text{?} \text{indicates text missing or illegible when filed}$$

Using C (from the previous measurement), R can be determined.

$$R = \frac{- T}{C ln ( 1 - \frac{m 2}{m 1} )}$$

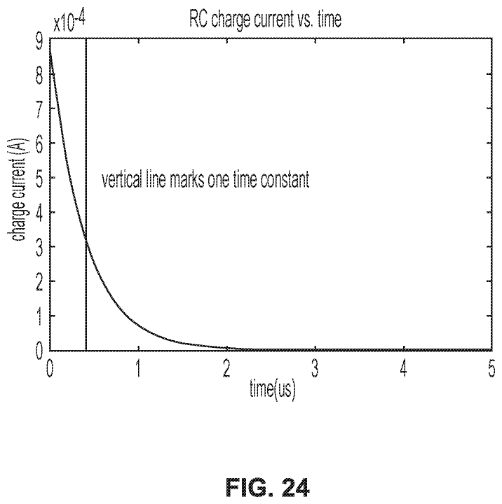

The first (e.g., polar fluid) resistance can be sensitive to temperature. For example, simulations show it can be about 3 times more sensitive than at least some thermistors that could be used for temperature measurements. Accordingly, this approach can be used to determine the temperature of the liquid lens. For example, a lookup table can be used to determine the temperature from the determined resistance. FIG. 24 shows an example plot of the charge current over time for an example lens electrode. In this example, the capacitance can be C=5 pF, the resistance can be R=80 K, and voltage can be 70 V. A first integration can stop at the vertical line, and the integration can capture 63% of the charge. A second integration can integrate for at least 2 microseconds, and can capture substantially all the charge. Comparing the first and second integrations can be indicative of the resistance in the liquid lens and/or of the temperature of the liquid lens.

### Active Lenses

Capacitance-based control and temperature determinations as disclosed herein can apply to various types of active optical elements (e.g., active lenses), where a capacitance can change. For example, in some cases, an active lens can include a fluid filled chamber which can be deformed by one or more piezoelectric elements. The compressing of the piezoelectric elements can change the distance between electrodes or other components of the active lens, which can thereby change the capacitance (e.g., similar to changing the gap distance between parallel plates in a capacitor). Accordingly, the capacitance can be measured and can be indicative of the active lens position, or optical power. The capacitance feedback and feedforward control systems and features disclosed herein can apply to the piezoelectric optical elements. A target capacitance can be set based at least in part on a target optical power, for example. The system can apply a voltage, monitor the resulting capacitance, and then adjust the voltage to reach the target capacitance.

The capacitance can also vary based on the temperature. The target capacitance can be based on the temperature as well as the target optical power. In some embodiments, the measured capacitance can be used to determine the temperature of the active lens, similar to the embodiments disclosed herein in connection with liquid lenses. For example, a voltage can be applied to the piezoelectric element(s), and a deformation can be produced. The capacitance can be measured. The temperature can be determined based on the applied voltage and the resulting capacitance, on a difference between an expected capacitance and a measured capacitance that results from applying a voltage, or by a voltage amount that is used to obtain a target capacitance, etc.

### Temperature Sensor Calibration

As discussed herein, and as shown in at least FIGS. 6 and 12, the same voltage differentials can produce different capacitance values and/or different amounts of optical power at different temperatures. Stated another way, the same capacitance (or optical power) can be produced at different voltage values, depending on the temperature. While holding constant voltages, the capacitance and/or optical power can drift as the temperature changes. While not being limited by theory, it is believed that the dielectric constant of the insulating material 24 (e.g., parylene) changes with temperature.

One or more voltages for driving a liquid lens can be determined based at least in part on a target optical power (e.g., focal length) and a temperature. The liquid lens system can have a temperature sensor 36 in some cases, which can provide the temperature information. In some cases, the temperature information can be determined by comparing an applied voltage and a resulting capacitance. The liquid lens system can include a sensor that provides information indicative of the capacitance. In some implementations, both a temperature sensor and a capacitance/voltage temperature determination can be used. For example, a temperature determined based on the capacitance and voltage can be used to calibrate a temperature sensor. A resistive element of a temperature sensor (e.g., a resistance temperature detector) can experience corrosion over time, which can affect the resistance of the material. Thus, the same temperature could result in different resistance values and different temperature readings over time as the resistive material (e.g., at the resistive material of the resistance temperature detector (RTD), contact pads, and/or interconnection with the controller) corrodes or otherwise changes. Thus, periodic or intermittent calibrations can be performed to at least partially compensate for corrosion or other changes to the temperature sensor. Other types of temperature sensors can also be calibrated using a temperature determined from a voltage and resulting capacitance, such as to at least partially counter other types of sensor degradation.

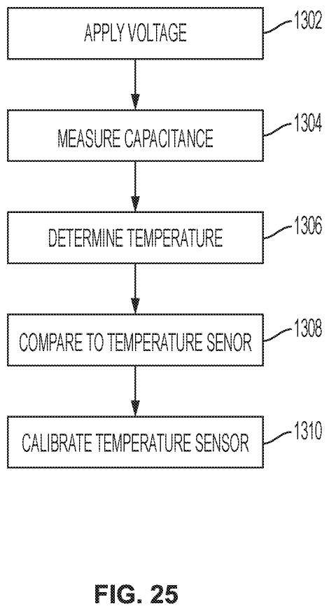

FIG. 25 is a flowchart of an example method for calibrating a temperature sensor for an active lens system, which can have a liquid lens or other variable focus lens, as discussed herein. At block 1302, a voltage can be applied, such as a voltage differential between a first electrode 22 and a second electrode 26. A capacitance that results from the applied voltage can be determined at block 1304. A lens sensor can provide information indicative of a capacitance that results in the lens as a result of the applied voltage. In some cases, a capacitance value can be determined. In some cases, a voltage value or other type of signal can be provided that is correlative, or otherwise indicative, of the capacitance. In some cases, a specific capacitance value can be determined. If a liquid lens has multiple driving electrodes 22, voltage differentials of substantially the same values can be applied to each of the driving electrodes 22 (e.g., between each of driving electrodes 22 and second, or common, electrode 26). Information that is indicative of the capacitance corresponding to each of the driving electrodes 22 can be determined and combined (e.g., averaged) in some cases. Alternatively, a voltage can be applied and capacitance information can be obtained for a single one of the driving electrodes.

At block 1306, a temperature can be determined from the voltage and information indicative of the resulting capacitance. That determined temperature can be compared to a temperature or other information from the temperature sensor. In some cases, temperature values can be compared. In some cases, the resistance value of a resistive temperature sensor can be used for comparison. Any other suitable value from any suitable type of temperature sensor can be used. By way of example, an expected resistance value can be determined based on the temperature determined at block 1306 or otherwise based on the applied voltage at 1302 and resulting capacitance at 1304. The actual resistance value of the resistive element of the temperature sensor can be compared to the expected resistance value at block 1308. In some cases, the voltage can be adjusted (e.g., by a capacitance feedback approach) to reach a certain capacitance, and the voltage that provides that certain capacitance can be used to determine the temperature at 1306, or otherwise be used in the calibration as discussed herein. In some cases, a certain temperature calibration voltage can be applied and the capacitance information (e.g., capacitance value or associated voltage or other indicative value) that results from that temperature calibration voltage can be used to determine the temperature at 1306, or otherwise be used in the calibration as discussed herein. Accordingly, in some cases, the system can jump to the same temperature calibration voltage each time the calibration is performed. The calibration voltage can be a relatively high voltage because the temperature can have a greater effect on the capacitance at higher voltages, as shown in FIG. 12. For example, a value of about 65 volts can be used for calibrating the temperature sensor, or for other instances of determining the temperature (e.g., as in FIG. 13). The temperature can be determined or the temperature sensor can be calibrated at a voltage value or a capacitance value that is within the top about 2%, about 5%, about 10%, about 15%, about 20%, about 25%, about 30%, about 40%, about 50%, of the operational range, or any values or ranges therein, although any suitable voltage and/or capacitance values can be used. In some cases, the voltage and capacitance can be compared for the parameters that are already being applied to the lens. This can be particularly useful for temperature determinations or calibrations performed during active operation of the lens. Thus, the fluid interface would not need to move to a different position for determining the temperature or for calibrating the temperature sensor. Accordingly, the system can determine the temperature and/or calibrate the temperature sensor using different voltages and/or different capacitance values at different times.

At block 1310, the temperature sensor can be calibrated based at least in part on the comparison of block 1308. For example, a lookup table, formula, equation, algorithm, or correction factor can be adjusted to at least partially compensate for a difference identified by the comparison at block 1308. Computer readable memory can contain a lookup table that defines a relationship between resistance values and temperatures, and one or more values in the lookup table can be adjusted, rewritten, or otherwise changed, for example, so that the temperature information from the temperature sensor more closely matches the temperature as determined based on the applied voltage and resulting capacitance. The values in the lookup table for the specific temperatures determined and/or measured can be changed, and other values in the lookup table can be changed as well, for example, to compensate for the corrosion or other temperature sensor degradation. For example, a uniform or linear adjustment can be made across the values of the lookup table, although other non-linear adjustments can by applicable in some implementations. A formula or equation or algorithm can be stored in the memory and can be adjusted similar to the changes discussed in connection with lookup tables.

In some implementations, the memory can contain a lookup table, formula, equation, or algorithm that defines a relationship between target optical power (e.g., focal length) and temperature sensor readings (e.g., resistance of an RTD) and capacitance, which can be used for closed-loop feedback control based on capacitance. For example, a lookup table can be similar to FIG. 7, but with resistance along the X axis instead of temperature. The temperature sensor can be calibrated by shifting the values in the table (e.g., to the right or left in a lookup table similar to FIG. 7). In some cases, values in the lookup table can be changed by moving the values within the table, rather than by altering the values themselves. For example, if it were determined that a certain resistance value corresponds to 19 degrees C. rather than 20 degrees C. (e.g., due to corrosion), then the values in the table can be shifted to the right. New values can be added to the lookup table at the right edge. In some cases, the memory can store values outside the usable range of the lookup table so that the values in the usable range of the table can be shifted. In some embodiments, the memory can store one or more formulas, equations, or algorithms for recalculating values in the lookup table, rather than shifting the existing values.

In some implementations, the memory can contain a lookup table, formula, equation, or algorithm that defines a relationship between target optical power (e.g., focal length) and temperature sensor readings (e.g., resistance of an RTD or temperature values) and voltage, which can be used for open-loop control (e.g., without capacitance feedback). For example, a lookup table can be similar to FIG. 7, but with resistance along the X axis instead of temperature, and with voltage values rather than capacitance values. The system can still have a sensor configured to provide information that is indicative of the capacitance, even though the capacitance is not used for feedback control in this example. The capacitance can be used for calibrating the temperature, as discussed herein. The temperature can be used at least to compensate for flexing of the window(s). Calibrating the temperature sensor can be performed by shifting values in the lookup table or by recalculating values within the lookup table. In some cases, capacitance feedback or other closed-loop control can be used, and the lookup table discussed can be used for determining an initial voltage value to be applied or for a feed-forward portion of the control system.

The temperature, resistance, capacitance, voltage, or other value comparisons and adjustments can be performed using digital or analog approaches. The system can include one or more analog to digital converters, in some cases. In some cases, block 1306 can be omitted. For example, a difference between an expected capacitance and a measured or determined capacitance can correlate to or otherwise indicate a temperature, even without determining an actual temperature value. Similarly, a difference between an expected voltage and an actual voltage that provide a particular capacitance can correlate to or otherwise indicate the temperature, without needing to determine an actual temperature value. For example, a voltage can be applied, and information indicative of a resulting capacitance can be obtained. In some cases, a capacitance value can be determined, and in other implementations, a resulting voltage value can be indicative of the capacitance, as disclosed for example in WO 2018/187587, which is incorporated by reference herein. An expected resistance value can be determined from the information indicative of capacitance (which can be a voltage value). The resistance value of the resistive temperature sensor can be compared to the expected resistance value, and the difference can be used to determine whether to adjust the lookup table, in what direction to adjust values, and/or how much adjustment to apply.

In some cases, a threshold can be applied to the comparison of block 1308. For example, if the compared values are within a threshold amount of each other, no change is applied to the calibration of the temperature sensor (e.g., no adjustment of the lookup table values). But if the compared values (e.g., determined temperature vs. temperature from sensor or expected resistance vs. measured resistance) at block 1308 differ by the threshold amount or more, then a recalibration can be applied at block 1310. Accordingly, in some instances, block 1310 can be omitted when no adjustment to the calibration is needed. The threshold can be about 1 ohm, or about 2 ohms, or about 3 ohms, or about 4 ohms, or more, or any values or ranges therebetween, or any other suitable values depending on the sensor or other components that are used.

The temperature sensor can be calibrated (e.g., using the process of FIG. 25 or other process disclosed herein) periodically or intermittently. The calibration can be performed about one, two, three, four, five, or six times each minute, each hour, each day, each week, or each month, or about once every one, two, three, four, five, or six minutes, hours, days, weeks, or months, or any values or ranges therein, although any suitable intervals can be used. Regular or irregular intervals can be used for calibration. In some cases, the calibration can be performed during each startup process for a camera system. In some cases, the calibration can be performed during the startup process for the camera system, after a threshold amount of time has passed since a previous calibration. In some cases, the calibration can be performed during an idle time of a camera, between frames of a video capture, etc. (e.g., after an amount of time has passed since a prior calibration). In some cases, the calibration can be interrupted or delayed in response to a command received by or delivered to the lens or camera system. In some cases, the calibration of the temperature sensor can be performed at a time when there is little or no capacitance drift, as discussed herein.

In some cases, the temperature sensor can be omitted, and the temperature can be determined based on the applied voltage and resulting capacitance, as discussed herein. Using a temperature sensor, which can be calibrated as discussed herein, can be beneficial by using less computations, by being faster, by less moving of fluids in the liquid lens, as compared to some implementations of determining the temperature based on the voltage and capacitance.

### Capacitance Drift

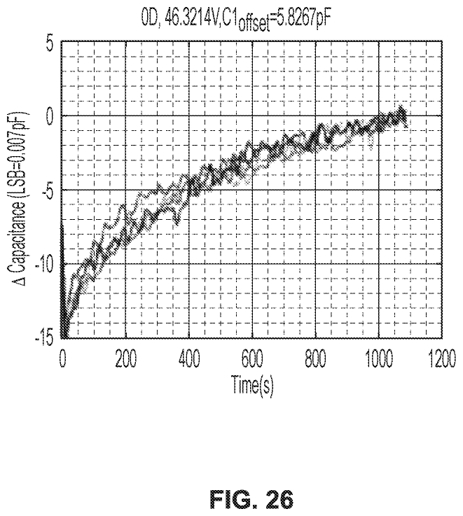

In some cases, the capacitance can change or drift even when the voltage and temperature are both constant. FIG. 26 is a plot that shows the capacitance changing over time when temperature is constant and the voltage is held at 46.3214 volts, which in this example is the default voltage for 0 diopters or a substantially flat fluid interface (e.g., sometimes referred to as a zero crossing voltage). The plot of FIG. 26 has time on the X-axis and shows the capacitance change over a time period of about 1100 seconds. The Y-axis shows the capacitance difference from the final average capacitance value after the time period. At 0 seconds, the capacitance is about 15 pF below the final capacitance value. Over the next about 1100 seconds, the capacitance increases over time so that the capacitance difference goes from about −15 pF to about 0 pF. Accordingly, in this example, when the liquid lens was held as the zero-crossing voltage of 46.3214 volts, the capacitance drifted by about 15 pF over the course of about 1100 seconds. Without being limited by theory, it is believed that the change in capacitance can be a result at least in part of charge buildup in the lens.

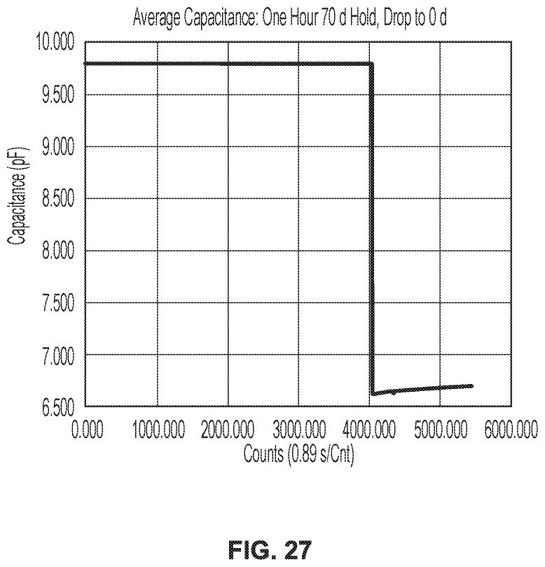

FIG. 27 is a plot showing a capacitance over a period of time of about 80 minutes. The X-axis shows time in units of counts, with 0.89 seconds per count. The liquid lens is held at 70 diopters for about one hour (e.g., about 4,044 counts), at which point the capacitance is at a substantially steady state at about 9.8 pF. At about 4,044 counts, the the optical power is transitioned to 0 diopters. The capacitance drops from about 9.8 pF to about 6.63 pF. Then over the next about 20 minutes (e.g., about 1,350 counts) the capacitance drifts up to about 7.72 pF. FIG. 27 shows that when the optical power of the liquid lens is changed, the charge can reset and the capacitance drift can restart.

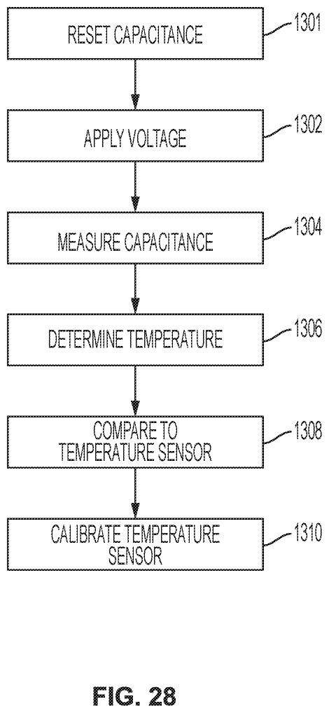

FIG. 28 is a flowchart of a method, which can be similar to the method of FIG. 25, except that block 1301 has been added to FIG. 28. At block 1301, the capacitance drift can be reset. For example, the voltage can be changed from a first voltage to a second voltage or from a first optical power to a second optical power, which can reset or reduce the charge accumulation, or capacitance drift. In some cases, the first voltage and the second voltage can be sufficiently different to sufficiently reset or reduce the capacitance drift, as discussed herein. For example, the first voltage and the second voltage can differ by about 5 volts, about 10 volts, about 15 volts, about 20 volts, about 25 volts, about 30 volts, about 40 volts, about 50 volts, or more, or any values or ranges therebetween, although any suitable voltage difference can be used, depending on other parameters of the liquid lens. The first optical power and the second optical power can differ by about 10 diopters, about 15 diopters, about 20 diopters, about 25 diopters, about 30 diopters, about 40 diopters, about 50 diopters, about 60 diopters, about 70 diopters, about 80 diopters, about 90 diopters, about 100 diopters, or more, or any values or ranges therebetween, although any suitable change in optical power can be used, such as depending on the operational range and other parameters of the lens.

The application of the voltage at block 1302 can be the transition from the first voltage to the second voltage. Upon startup, the transition from 0 volts to applying the voltage at 1302 can reset the capacitance for block 1301. Accordingly, in some cases blocks 1301 and 1302 can be performed together. In some cases, the system can transition from a first voltage to a second voltage for block 1301 to reset the capacitance drift and then apply the voltage of block 1302 for determining the temperature. For example, if it is time to perform the temperature sensor calibration and the voltage is already at (or within a threshold value of) the voltage to be applied at block 1302, the system can first transition to a different voltage (e.g., outside the threshold), and then apply the voltage at block 1302. Applying the different voltage and/or then applying the voltage of block 1302 can act to reset the capacitance drift in this example. In some embodiments, the voltage applied at block 1302 can vary depending on the previous voltage so that the voltage change is sufficient to reset the capacitance drift for block 1301. For example, the system can apply 65 volts at block 1302. But if the voltage is already at 65 volts (or within a threshold range thereof), the system can transition to 40 volts (or any other suitable value) instead. Or in some cases, the system can transition to 40 volts (or any other suitable value) for a time and then transition to 65 volts for block 1302.

The capacitance can be measured at block 1304 during a time with substantially no capacitance drift (e.g., before any substantial capacitance drift following the reset). For example, the information indicative of the capacitance can be obtained at block 1304 within about 20 seconds, about 15 seconds, about 10 seconds, about 5 seconds, about 3 seconds, about 2 seconds, about 1 second, about 0.5 seconds, about 0.25 seconds, about 0.1 seconds, about 0.075 seconds, about 0.05 seconds, or less, of the capacitance drift reset or reduction, or any ranges or values therein, although any suitable timing can be used such as depending on the capacitance drift rate, the processing speed of the system, the settling time of the fluids, etc. In some cases, the measurement can take about 50 ms, about 75 ms, about 100 ms, about 150 ms, about 200 ms, about 300 ms, or any values or ranges therebetween, although other timing is also possible depending on the system parameters.

In some cases, the system does not use feedback control (e.g., closed loop control) based on the capacitance, which could result in errors because of capacitance drift. In some embodiments, the system can use open loop control or feed forward control, as described herein. The open loop control can determine voltage values to be applied to the lens based at least in part on the target optical power (e.g., focal length). The voltage values can also be based on the temperature, which can account for bending or flexing of the window(s), as discussed herein. A higher target optical power can result in a higher voltage. A higher temperature can result in more flexing of the window(s), so that the fluid interface does not need to curve as much thereby resulting in a lower voltage. A lookup table, formula, equation, or algorithm can define the relationships between the target optical power and/or temperature and voltage. The fluid interface can be tilted using voltage offsets or additional voltage signals or variations, as discussed herein.

The system can use the capacitance information to confirm and calibrate the voltage parameters. If the system does not use feedback to confirm the fluid interface is at the appropriate position, the system can periodically or intermittently check whether the voltage values are providing the expected fluid interface position (e.g., and the resulting capacitance), and the system can calibrate the voltage parameters by making changes or adjustments if the voltage values do not produce the expected fluid interface position (e.g., and resulting expected capacitance).

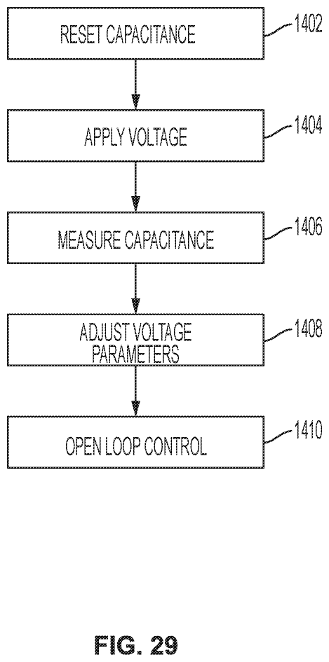

FIG. 29 is a flowchart of an example embodiment of a method for calibrating voltage parameters for a lens system, such as having a liquid lens or other variable focus lens. At block 1402, the capacitance drift or charge can be reset, similar to block 1301 discussed herein. For example, the voltage can be changed from a first voltage to a second voltage, wherein the voltage change is sufficient to reset or significantly reduce the capacitance drift, as discussed herein. The capacitance drift can start anew, but the calibration of the voltage parameters can be performed before the capacitance has drifted significantly, such as within the time values and ranges discussed in connection with FIG. 28. At block 1404, a voltage can be applied to the lens. The voltage can be the zero-crossing voltage, although any other suitable voltage within the operational range of the lens can be used. Changing to the voltage of 1404 can implement the resetting of the capacitance drift at block 1402. Accordingly blocks 1402 and 1404 can be performed together. At block 1406 information indicative of the capacitance that results from the applied voltage (e.g., the zero-crossing voltage) can be measured or otherwise obtained.

At block 1408, the voltage parameters can be adjusted based on the applied voltage (block 1404) and the information indicative of the resulting capacitance (block 1406). The voltage parameters can be adjusted by changing values of a lookup table, or by changing aspects of a formula, equation, or algorithm, etc. For example, computer readable memory can store an expected capacitance value (e.g., 5.8 pF) for a lens position (e.g., flat fluid interface or zero-crossing position with 0 diopters) that corresponds to the applied voltage (e.g., a zero-crossing voltage such as 46 volts). If the applied voltage (e.g., the zero-crossing voltage of 46 volts in this example) does not provide the expected capacitance value (e.g., 5.8 pF), the lookup table, formula, equation, or algorithm can be changed so that a new voltage value (e.g., 46.5 volts) corresponds to the lens position (e.g., the flat, zero-crossing position with 0 diopters) and provides the expected capacitance value (e.g., 5.8 pF). The voltages associated with the other lens positions (and associated capacitance values) can be adjusted as well by the changes to the lookup table, formula, equation, or algorithm. For example, the values of the lookup table can be shifted or recalculated. The voltage values can be adjusted uniformly, linearly, or non-linearly. When the voltage does not produce the expected capacitance value, the voltage can be adjusted, such as using a limited feedback process, until the new voltage (e.g., 46.5 volts) that does produce the expected capacitance value (e.g., 5.8 pF) is found. The difference between the original voltage (e.g., the original zero-crossing voltage of 46 volts) and the new voltage (e.g., the new zero-crossing voltage of 46.5 volts) can dictate the direction and/or magnitude of the change to the other voltage values that correspond to other lens positions and focal lengths as well. For example, all the voltage values can be shifted by 0.5 volts due to the difference between 46 volts and 46.5 volts. In another example, the voltages for some lens positions could change by more or less than 0.5 volts, depending on the linear or non-linear relationship between the voltages and lens positions, which can be affected by the particular parameters of the lenses.

Various examples discuss the measured capacitance in terms of a true capacitance value, such as measured in pF. However, in some cases, the capacitance information can be a voltage or other value that is correlative to or otherwise indicative of the capacitance. In some cases, the method of FIG. 29 can also consider the temperature. For example, the lookup table, formula, equation, or algorithm can determine a voltage based on at least the target optical power and the temperature. Accordingly, the method can access temperature information, such as from a temperature sensor 36, or from a determination based on the capacitance and voltage. If a temperature sensor 36 is used, the temperature sensor can be calibrated, according to the embodiments disclosed herein. Block 1408 can determine an expected capacitance value for the applied voltage at the temperature of the lens. If adjustments are made to the voltage parameters, those adjustments can be applied (e.g., uniformly, linearly, or non-linearly) across the operational range of temperatures and focal lengths. In some cases, multiple different voltages and resulting capacitance can be applied and obtained and used to calibrate the voltage parameters. In other embodiments, a single value (e.g., the zero-crossing) is sufficient.

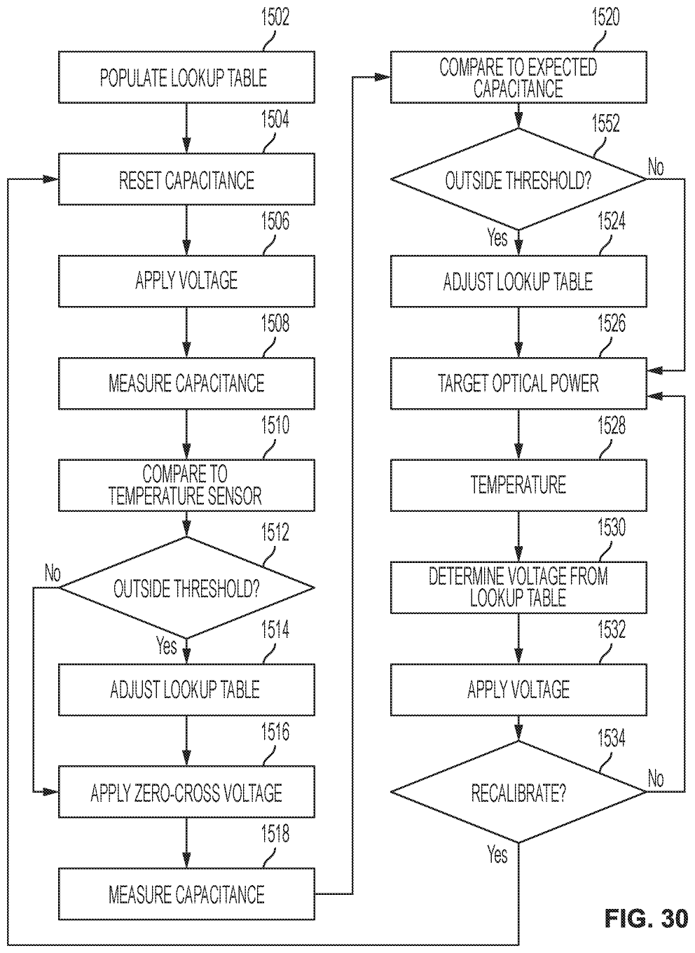

FIG. 30 is a flowchart of an example method for calibrating a lens system, such as having a liquid lens or other variable focus lens. The method of FIG. 30 can use open loop or feed forward control, as well as calibration techniques similar to those of FIGS. 25, 28, and 29. At block 1502, a lookup table can be populated. For example, an electro-optical (EO) test can be performed at a reference temperature (e.g., 20 degrees C.) to populate the values for the lookup table. The EO test can measure the diopter of the lens and can monitor the applied voltages, for example, while maintaining a substantially constant reference temperature. The lookup table can be populated empirically. The lookup table can include inputs indicative of a temperature (e.g., a resistance of an RTD or a temperature value in degrees) and an optical power (e.g., diopters or focal length), and the lookup table can include output voltage values, which can be configured to provide the specified optical power while at the temperature (e.g., the reference temperature). The values for other temperatures can be extrapolated from the EO test performed at the reference temperature, in some cases.

At block 1504, the capacitance drift or charge can be reset, similar to block 1301 discussed herein. For example, the voltage can be changed from one voltage to another voltage, wherein the voltage change is sufficient to reset or significantly reduce the capacitance drift, as discussed herein. The capacitance drift can start anew, but the calibration can be performed before the capacitance has drifted significantly, such as within the time values and ranges discussed in connection with FIG. 25 or 28. At block 1506, a first voltage can be applied to the lens. The first voltage can be a temperature calibration voltage (e.g., 65 volts in some examples). Changing to the voltage of block 1506 can result in the capacitance drift reset of block 1504. At block 1508 the capacitance that results from the voltage of block 1506 can be measured. In some cases, a sensor can provide a voltage or other value that is indicative of the capacitance, or a true capacitance value can be determined. At block 1510, the voltage and/or capacitance, or information derived therefrom, can be compared to information from a temperature sensor. For example, an expected resistance value or expected temperature value can be determined from the voltage and resulting capacitance (e.g., from a difference between a measured capacitance and a reference capacitance at a reference temperature as described herein) and can be compared to the resistance or temperature determined from the temperature sensor (e.g., which can be a resistance temperature detector). At block 1512 a determination can be made of whether a comparison difference of block 1510 is outside of a threshold. If it is outside the threshold, the method can proceed to block 1514 and the lookup table can be adjusted. If it is inside the threshold, block 1514 can be skipped and no adjustment to the lookup table is made. Blocks 1504 to 1514 can be similar to or the same as the methods of FIGS. 25 and 28 and the alternatives thereof.

At block 1516, a second voltage can be applied. The second voltage can be a zero-crossing voltage, although other voltage values could be used, as discussed herein. At block 1518, the resulting capacitance is measured. Information indicative of the capacitance can include a true capacitance value, or a voltage value, or other type of information that is indicative of the capacitance that results from applying the voltage of block 1516. At block 1520, the capacitance information can be compared to expected capacitance information. At block 1522 a determination can be made of whether the compared difference is outside a threshold. If it is outside the threshold, then the lookup table is adjusted, such as similar to the discussion of 1408. The adjustment can change (e.g., calibrate) the zero-crossing voltage, and/or other relationships between focal lengths and voltage values. If it is not outside the threshold at block 1522, the adjustment can be skipped, and the method can proceed to block 1526. The blocks 1516 to 1524 can be similar to, or the same as, the method of FIG. 29 and the alternatives thereof. At block 1520, the comparison can be to an expected capacitance for the temperature of the lens, which can be determined from the temperature sensor (e.g., calibrated according to block 1514), or which can be the temperature determined from the applied voltage (e.g., block 1506) and resulting capacitance (e.g., block 1508).

At block 1526, the system can obtain a target optical power, such as from an autofocus system, or user input, etc. At block 1528, temperature information can be obtained, such as from the temperature sensor 36. The temperature information can be indicative of the temperature of the variable focus lens (e.g., liquid lens). At block 1530 a voltage can be determined from the lookup table (which can be an adjusted lookup table that was changed at block 1514 and/or block 1524) based on the target optical power and the temperature information. In some cases, the voltage value(s) can also be affected by other things, such as a target tilt amount angle and tilt azimuthal direction. Accordingly, the method for adjusting the optical power of the lens can also be used to adjust the optical tilt of the lens (e.g., by adjusting one or more individual driving electrodes to different positions rather than adjusting all of the driving electrodes to the same position). Accordingly, different operations can be performed for the different driving electrodes, such as to apply different voltages and to position the fluid interface at different positions for the different driving electrodes. In some cases, voltage offsets from a base voltage can be applied to produce the tilt. At block 1532, the voltage can be applied to the lens (e.g., a liquid lens). At block 1534, a determination is made of whether to recalibrate the system. For example, if sufficient time has passed it can be time to recalibrate. For recalibration, the method can return to block 1504 and can repeat steps of the method. If it is not time to recalibrate, the method can return to block 1526 and can continue controlling the system with an open loop control approach. For example, new target optical power information can be received at 1526 or new temperature information can be received at block 1528. Then a new voltage value can be determined from the lookup table at block 1530, and that new voltage value can be applied at block 1532. The process can continue to loop through blocks 1526 to 1534 (e.g., as an open loop or feed forward control process) until it is time to recalibrate. Recalibration can be performed upon startup of the camera, opening of a camera app on a smartphone, or at other suitable intervals. Recalibration can be prescribed at regular or irregular intervals, which can be postponed or adjusted, in some cases, depending on the use of the lens or associated camera system.

In some embodiments, block 1502 can be omitted. The device can have a lookup table that is prepopulated, for example. Although some embodiments are discussed in connection with lookup tables, other approaches like a formula, equation, or algorithm can be used instead. In some cases, the resetting of the capacitance drift at block 1504 can be omitted, for example, if the capacitance drift is reduced or otherwise compensated for. In some cases, the calibration can be performed before the capacitance drifts significantly, such as within about 20 seconds, about 15 seconds, about 10 seconds, about 5 seconds, about 3 seconds, about 2 seconds, about 1 second, about 0.5 seconds, about 0.25 seconds, about 0.1 seconds, about 0.075 seconds, about 0.05 seconds, or less, or any ranges or values therein, although any suitable timing can be used. In some cases, the calibration can take about 50 ms, about 75 ms, about 100 ms, about 150 ms, about 200 ms, about 300 ms, or any values or ranges therebetween, although other timing is also possible depending on the system parameters. One or more calibrations (e.g., blocks 1302 to 1310, blocks 1302 to 1304, blocks 1404 to 1406, blocks 1404 to 1408, blocks 1506 to 1524, blocks 1506 to 1514, blocks 1516 to 1524, or blocks 1506 to 1524) can be performed before the capacitance drifts by about 0.25 pF, by about 0.5 pF, by about 1 pF, by about 2 pF, by about 3 pF, by about 4 pF, by about 5 pF, or any values or ranges therein, although other configurations are possible.

In some cases, the determination blocks 1512 and 1522 can be omitted. For example, the lookup table can be adjusted for any variations, rather than applying a threshold range for which no adjustment is made. In some embodiments, the blocks 1514 and 1524 can be combined so that the lookup table can be adjusted once during the calibration, instead of two times. Block 1514 can be omitted, and block 1524 can adjust the lookup table based on the comparisons of both block 1510 and block 1520. In some cases, the lookup table, formula, equation, or algorithm is not adjusted, but a correction factor can be adjusted and can be applied with the lookup table, formula, equation, or algorithm, such as to determine the voltages to be applied to the lens.

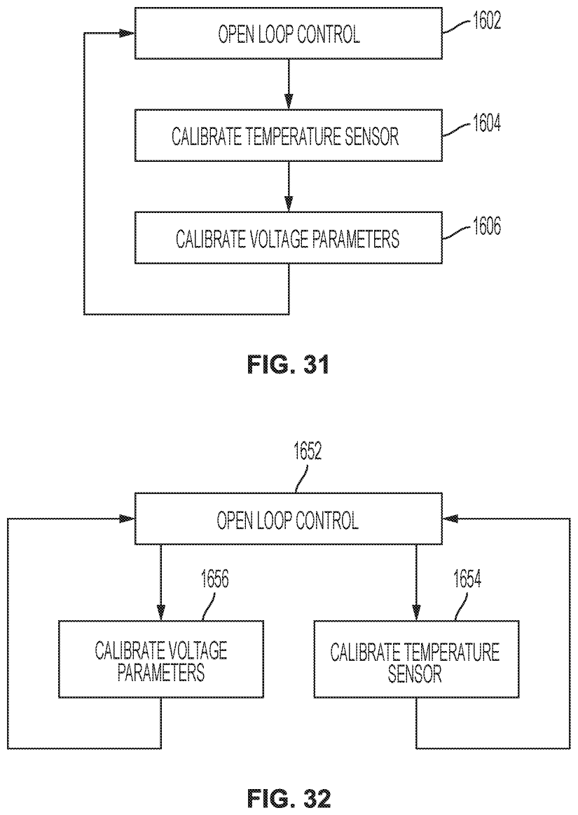

FIG. 31 shows an example embodiment of a method. At block 1602 the system can perform open loop control of a variable focus lens (e.g., a liquid lens), as discussed herein. The open loop control does not use capacitance feedback in some embodiments. At block 1604, the system can interrupt the open loop control to perform a calibration of the temperature sensor. Block 1604 can use features similar to, or the same as, FIGS. 25, 28, and/or 30. At block 1606, the system can calibrate the voltage parameters, such as using features similar to, or the same as FIGS. 29 and/or 30. The calibration processes 1604 and/or 1606 can use a capacitance sensor (e.g., which can output a true capacitance value or a voltage or other value that is indicative of the capacitance). In some cases, a limited capacitance feedback process can be used to determine a voltage that corresponds to a particular capacitance (e.g., for temperature determination in block 1604 or for determining a new zero-crossing voltage value in block 1606). After calibration, the system can transition back to open loop control.

In FIGS. 30 and 31, the calibration of the temperature sensor and other voltage relationships can be performed together (e.g., one after the other). In other implementations, the types of calibration can be performed separately, and at different intervals. FIG. 32 shows a flowchart of an example embodiment of a method. At block 1652 the system can perform open loop control of a variable focus lens (e.g., a liquid lens), as discussed herein. The open loop control does not use capacitance feedback, in some embodiments. At block 1654, the system can interrupt the open loop control to perform a calibration of the temperature sensor. Block 1654 can use features similar to, or the same as, FIGS. 25, 28, and/or 30. After the calibration of block 1654 the system can return to open loop control of block 1652. At block 1656, the system can calibrate the voltage parameters, such as using features similar to, or the same as FIGS. 29 and/or 30. After block 1656, the system can return to open loop control of block 1652. The calibration of block 1654 can be performed without the calibration of block 1656, and the calibration of block 1656 can be performed without the calibration of block 1654. The calibrations at blocks 1654 and 1656 can be performed at different intervals, which can each be regular or irregular intervals. For example, in some cases, the temperature sensor calibration of block 1654 may be performed less frequently (e.g., once per day or upon camera startup) than the calibration of block 1656 (e.g., once per minute). Various other time intervals can be applied to either of the calibration intervals, such as the timing discussed with FIG. 25 and/or FIG. 30.

### Additional Disclosure

In some embodiments, a liquid lens system comprises a chamber, a first fluid in the chamber, a second fluid in the chamber, wherein an interface is between the first fluid and the second fluid, a first electrode insulated from the first and second fluids, a second electrode in electrical communication with the first fluid, a signal generator configured to supply a voltage differential between the first electrode and the second electrode, wherein a position of the interface is based at least in part on voltage differentials applied between the first electrode and the second electrode, a sensor configured to output information that is indicative of a capacitance between at least the first fluid and the first electrode, a controller configured to apply a voltage differential between the first electrode and the second electrode, receive information indicative of the capacitance that results from applying the voltage differential, and determine a temperature of the liquid lens based at least in part on the applied voltage differential and the information indicative of the resulting capacitance.

In some embodiments, the controller is configured to access a target optical power for the liquid lens, and determine a target capacitance based at least in art on the target optical power and the determined temperature. Additionally, or alternatively, the controller is configured to determine an optical power from flexing or movement of a window of the liquid lens based at least in part on the determined temperature, and determine the target capacitance based at least in part on the determined optical power from flexing or movement of the window. Additionally, or alternatively, the controller is configured to access a target optical power for the liquid lens, and determine an optical power from flexing or movement of a window of the liquid lens based at least in part on the determined temperature, and determine a target optical power for the interface based at least in part on the target optical power for the liquid lens and the optical power from flexing or movement of the window. Additionally, or alternatively, the sensor configured to directly measure the capacitance. Additionally, or alternatively, the sensor is configured to indirectly determine the capacitance. Additionally, or alternatively, the sensor comprises a current mirror. Additionally, or alternatively, the liquid lens system has a hysteresis of less than 0.5 diopters, less than 0.2 diopters, less than 0.1 diopters, or less than 0.075 diopters across the operational range of the liquid lens. Additionally, or alternatively, the voltage differential is a temperature test voltage value different from a driving voltage value that is configured to produce a target optical power for the liquid lens. Additionally, or alternatively, the temperature test voltage value is a higher voltage than the driving voltage value. Additionally, or alternatively, the liquid lens comprises a plurality of first electrodes that are insulated from the first fluid and the second fluid, and the controller is configured to apply different voltage differentials to the plurality of first electrodes, receive information indicative of capacitances for the plurality of first electrodes that result from applying the voltage differentials, determine an average of the voltage differentials applied to the plurality of first electrodes, determine an average of the capacitances for the plurality of first electrodes, and determine the temperature of the liquid lens based at least in part on the average of the voltage differentials and the average of the capacitances.

In some embodiments, a liquid lens system comprises a chamber, a first fluid in the chamber, a second fluid in the chamber, wherein an interface is between the first fluid and the second fluid, a first electrode insulated from the first and second fluids, a second electrode in electrical communication with the first fluid, a signal generator configured to supply a voltage differential between the first electrode and the second electrode, wherein a position of the interface is based at least in part on voltage differentials applied between the first electrode and the second electrode, a controller configured to access a target optical power, access a temperature of the liquid lens, and determine a target capacitance based at least in part on the target optical power and the temperature of the liquid lens. Additionally, or alternatively, the controller is configured to apply a voltage differential between the first electrode and the second electrode, receive information indicative of the capacitance that results from applying the voltage differential, and determine the temperature of the liquid lens based at least in part on the applied voltage differential and the information indicative of the resulting capacitance.

In some embodiments, a variable focus lens has a hysteresis of less than 0.5 diopters, less than 0.2 diopters, less than 0.1 diopters, or less than 0.075 diopters across the operational range of the variable focus lens.

In some embodiments, the variable focus lens is an electrowetting liquid lens. Additionally, or alternatively, the variable focus lens is a piezoelectric active lens.

In some embodiments, a variable focus lens system comprises a variable focus lens, one or more electrodes, a signal generator configured to supply voltage to the one or more electrodes to vary the focal length of the variable focus lens, and a controller configured to apply a voltage to the one or more electrodes, receive information indicative of a capacitance that results from the applied voltage, and determine a temperature of the variable focus lens based at least in part on the capacitance or applied voltage. Additionally, or alternatively, the variable focus lens comprises an electrowetting liquid lens. Additionally, or alternatively, the variable focus lens comprises a piezoelectric active lens.

In some embodiments, a variable focus lens system comprises a variable focus lens, one or more electrodes, a signal generator configured to supply voltage to the one or more electrodes to vary the focal length of the variable focus lens, and a controller configured to access a target optical power, access a temperature of the lens, and determine a target capacitance based at least in part on the target optical power and the temperature. Additionally, or alternatively, the controller is configured to apply a voltage to the one or more electrodes, receive information indicative of a capacitance that results from the applied voltage, and determine a temperature of the variable focus lens based at least in part on the capacitance or applied voltage.

In some embodiments, a liquid lens system comprises a liquid lens comprising a chamber, a first fluid in the chamber, a second fluid in the chamber, wherein an interface is between the first fluid and the second fluid, a first electrode insulated from the first and second fluids, and a second electrode in electrical communication with the first fluid. A signal generator can be configured to supply voltage differentials between the first electrode and the second electrode, wherein a position of the interface is based at least in part on the voltage differentials applied between the first electrode and the second electrode. A capacitance sensor can be configured to output information that is indicative of a capacitance between at least the first fluid and the first electrode. A temperature sensor can be configured to output information that is indicative of a temperature of the liquid lens. Computer-readable memory can store a lookup table. A controller can be configured to cause the signal generator to apply a first voltage differential between the first electrode and the second electrode, receive information indicative of a capacitance that results from applying the first voltage differential, determine a temperature of the liquid lens based at least in part on the applied first voltage differential and the information indicative of the capacitance that results from the applying the first voltage differential, receive information from the temperature sensor, compare the determined temperature with the information received from the temperature sensor and update the lookup table based at least in part on the comparison, cause the signal generator to apply a second voltage differential between the first electrode and the second electrode, receive information indicative of a capacitance that results from applying the second voltage differential, compare the capacitance that results from applying the second voltage differential to an expected capacitance and update the lookup table based at least in part on the comparison, receive a target optical power, receive information from the temperature sensor, determine from the updated lookup table a third voltage differential based at least in part on the target optical power and the information from the temperature sensor, and cause the signal generator to apply the third voltage differential between the first electrode and the second electrode.

In some embodiments, the temperature sensor comprises a resistance temperature detector. Additionally, or alternatively, the controller is configured to compare the determined temperature with the information received from the temperature sensor by determining an expected resistance value for the determined temperature and comparing a resistance value from the temperature sensor to the expected resistance value. Additionally, or alternatively, the second voltage comprises a zero cross over voltage for forming a flat interface. Additionally, or alternatively, the controller is configured to compare the capacitance that results from applying the zero cross over voltage to the expected capacitance and update the lookup table by determining that the capacitance that results from applying the zero cross over voltage differs from the expected capacitance, determining a new voltage that provides the expected capacitance, and setting the zero cross over voltage to be the new voltage. Additionally, or alternatively, determining a new voltage that provides the expected capacitance comprises a capacitance feedback process that monitors the capacitance while changing the voltage until the expected capacitance is reached. Additionally, or alternatively, the controller is configured to reset capacitance drift before receiving the information indicative of the capacitance that results from applying the first voltage differential. Additionally, or alternatively, the controller is configured to change from an initial voltage to the first voltage to reset the capacitance drift. Additionally, or alternatively, the controller is configured to perform the following before the capacitance drifts by 3 pF: receive the information indicative of the capacitance that results from applying the first voltage differential, determine the temperature of the liquid lens based at least in part on the applied first voltage differential and the information indicative of the capacitance that results from the applying the first voltage differential, receive the information from the temperature sensor, compare the determined temperature with the information received from the temperature sensor and update the lookup table based at least in part on the comparison, cause the signal generator to apply the second voltage differential between the first electrode and the second electrode, receive the information indicative of the capacitance that results from applying the second voltage differential, and compare the capacitance that results from applying the second voltage differential to the expected capacitance and update the lookup table based at least in part on the comparison. Additionally, or alternatively, the controller is configured to determine the third voltage differential by determining an optical power from flexing or movement of a window of the liquid lens based at least in part on the information received from the temperature sensor, and determining an interface optical power based at least in part on the target optical power and the optical power from flexing or movement of the window, and determining from the updated lookup table the third voltage differential that corresponds to the interface optical power.

In some embodiments, a variable focus lens system comprises a variable focus lens, one or more electrodes, wherein a focal length of the variable focus lens is adjustable by supplying voltage to the one or more electrodes, a temperature sensor, and a controller configured to apply a voltage to the one or more electrodes, receive capacitance information indicative of a capacitance that results from the applied voltage, receive temperature information from the temperature sensor, and calibrate the temperature sensor based at least in part on the received temperature information, the applied voltage, and the received capacitance information.

In some embodiments, the controller is configured to calibrate the temperature sensor by changing values in a lookup table. Additionally, or alternatively, the lookup table is configured to receive inputs of temperature information and target optical power, and output voltage values for driving the variable focus lens. Additionally, or alternatively, the controller is configured to calibrate the temperature sensor by changing a formula, equation, algorithm, or correction factor. Additionally, or alternatively, the controller is configured to determine a temperature of the variable focus lens based at least in part on the applied voltage and the received capacitance information, compare the determined temperature with the received temperature information, and calibrate the temperature sensor based at least in part on the comparison. Additionally, or alternatively, the temperature sensor comprises a resistance temperature detector. Additionally, or alternatively, the controller is configured to determine an expected resistance based at least in part on the applied voltage and the received capacitance information, compare a resistance value from the temperature sensor to the expected resistance value, and calibrate the temperature sensor based at least in part on the comparison. Additionally, or alternatively, the controller is configured to use the calibrated temperature sensor for closed loop control with capacitance feedback. Additionally, or alternatively, the controller is configured to use the calibrated temperature sensor for open loop control. Additionally, or alternatively, the controller is configured to apply an additional voltage to the one or more electrodes, receive information indicative of a capacitance that results from the additional applied voltage, compare the capacitance that results from the additional applied voltage to an expected capacitance, and change a relationship between requested focal lengths and voltages applied based at least in part on the comparison. Additionally, or alternatively, the controller is configured to reset capacitance drift before receiving the capacitance information. Additionally, or alternatively, the controller is configured to transition from an initial voltage to the applied voltage to reset the capacitance drift. Additionally, or alternatively, the controller is configured to obtain a target optical power, receive temperature information from the temperature sensor, and determine at least one voltage to apply to the one or more electrodes based at least in part on the target optical power and the received temperature information. Additionally, or alternatively, the controller is configured to operate in a calibration mode that uses capacitance feedback and operate in a driving mode for driving the variable focus lens, wherein the driving mode does not use capacitance feedback.

In some embodiments, a variable focus lens system comprises a variable focus lens, one or more electrodes, wherein a focal length of the variable focus lens is adjustable by supplying a voltage to the one or more electrodes, and a controller configured to apply a voltage to the one or more electrodes, receive information indicative of a capacitance that results from the applied voltage, compare the capacitance that results from the applied voltage to an expected capacitance and change a relationship between requested focal lengths and voltages applied based at least in part on the comparison, and operate the variable focus lens with open loop control.

In some embodiments, the variable focus lens system comprises a temperature sensor. Additionally, or alternatively, the controller is configured to apply a temperature calibration voltage to the one or more electrodes, receive capacitance information indicative of a capacitance that results from the applied temperature calibration voltage, receive information from the temperature sensor, and change the relationship between the requested focal lengths and the voltages applied based at least in part on the information received from the temperature sensor, the applied temperature calibration voltage, and the received capacitance information. Additionally, or alternatively, the controller is configured to determine a temperature of the variable focus lens based at least in part on the applied temperature calibration voltage and the received capacitance information, compare the determined temperature with the information received from the temperature sensor, and change the relationship based at least in part on the comparison. Additionally, or alternatively, the temperature sensor comprises a resistance temperature detector. Additionally, or alternatively, the controller is configured to determine an expected resistance based at least in part on the applied temperature calibration voltage and the received capacitance information, compare a resistance value from the temperature sensor to the expected resistance value, and change the relationship based at least in part on the comparison. Additionally, or alternatively, the controller is configured to change the relationship by altering values of a lookup table. Additionally, or alternatively, the lookup table is configured to receive inputs of temperature information and target optical power and output voltage values for driving the variable focus lens. Additionally, or alternatively, the controller is configured to change the relationship by altering a formula, equation, algorithm, or correction factor. Additionally, or alternatively, the controller is configured to reset capacitance drift before receiving information indicative of a capacitance that results from the applied voltage. Additionally, or alternatively, the controller is configured to transition from an initial voltage to the applied voltage to reset the capacitance drift. Additionally, or alternatively, the controller is configured to obtain a target optical power, receive temperature information from a temperature sensor, and determine at least one voltage to apply to the one or more electrodes based at least in part on the target optical power and the received temperature information. Additionally, or alternatively, the controller is configured to apply feed forward control without capacitance feedback to drive the variable focus lens.

In the disclosure provided above, apparatus, systems, and methods for feedback and control of a lens are described in connection with particular example embodiments. It will be understood, however, that the principles and advantages of the embodiments can be used for any other systems, apparatus, or methods with a need for feedback and control responsive to an indication of capacitance. Although certain embodiments are described with reference to an example sample and hold voltage sensor, it will be understood that the principles and advantages described herein can be applied to other types of sensors. While some of the disclosed embodiments may be described with reference to analog, digital, or mixed circuitry, in different embodiments, the principles and advantages discussed herein can be implemented for different parts as analog, digital, or mixed circuitry. Moreover, while some circuits schematics are provided for illustrative purposes, other equivalent circuits can alternatively be implemented to achieve the functionality described herein. In some figures, four electrodes are shown. The principles and advantages discussed herein can be applied to embodiments with more than four electrodes or fewer than four electrodes.

The principles and advantages described herein can be implemented in various apparatuses. Examples of such apparatuses can include, but are not limited to, consumer electronic products, parts of the consumer electronic products, electronic test equipment, etc. The principles and advantages described herein relate to lenses. Examples products with lenses can include a mobile phone (for example, a smart phone), healthcare monitoring devices, vehicular electronics systems such as automotive electronics systems, webcams, a television, a computer monitor, a computer, a hand-held computer, a tablet computer, a laptop computer, a personal digital assistant (PDA), a refrigerator, a DVD player, a CD player, a digital video recorder (DVR), a camcorder, a camera, a digital camera, a copier, a facsimile machine, a scanner, a multi-functional peripheral device, a wrist watch, a clock, etc. Further, apparatuses can include unfinished products.

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. The program instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessor or controllers described herein can be coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to some embodiments, parts of the techniques disclosed herein are performed by one or more microprocessors in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A liquid lens system comprising:
a chamber;
a first fluid in the chamber;
a second fluid in the chamber;
a first electrode insulated from the first and second fluids;
a second electrode in electrical communication with the first fluid;
a signal generator configured to supply a voltage differential between the first electrode and the second electrode, wherein a position of an interface between the first fluid and the second fluid is based at least in part on voltage differentials applied between the first electrode and the second electrode;
a sensor configured to output information that is indicative of a capacitance between at least the first fluid and the first electrode; and
a controller configured to:
apply a voltage differential between the first electrode and the second electrode;
receive information indicative of a capacitance that results from applying the voltage differential; and
determine a temperature of the liquid lens based at least in part on the applied voltage differential and the information indicative of the resulting capacitance.

2. The liquid lens system of claim 1, wherein the controller is configured to:
access a target optical power for the liquid lens; and
determine a target capacitance based at least in part on the target optical power and the determined temperature.

3. The liquid lens system of claim 2, wherein the controller is configured to:
determine an optical power from flexing or movement of a window of the liquid lens based at least in part on the determined temperature; and
determine the target capacitance based at least in part on the determined optical power from flexing or movement of the window.

4. The liquid lens system of claim 1, wherein the controller is configured to:
access a target optical power for the liquid lens; and
determine an optical power from flexing or movement of a window of the liquid lens based at least in part on the determined temperature; and
determine a target optical power for the interface based at least in part on the target optical power for the liquid lens and the optical power from flexing or movement of the window.

5. The liquid lens system of claim 1, comprising:
a temperature sensor configured to output information that is indicative of a sensed temperature of the liquid lens; and
computer-readable memory storing a lookup table;
wherein the controller is configured to:
receive information from the temperature sensor;
compare the determined temperature with the information received from the temperature sensor and update the lookup table based at least in part on the comparison;
cause the signal generator to apply a second voltage differential between the first electrode and the second electrode;
receive information indicative of a second capacitance that results from applying the second voltage differential;
compare the second capacitance that results from applying the second voltage differential to an expected capacitance and update the lookup table based at least in part on the comparison;
receive a target optical power;
receive second information from the temperature sensor;
determine from the updated lookup table a third voltage differential based at least in part on the target optical power and the second information from the temperature sensor; and
cause the signal generator to apply the third voltage differential between the first electrode and the second electrode.

6. The liquid lens system of claim 5, wherein the second voltage differential comprises a zero cross over voltage for forming a flat interface.

7. The liquid lens system of claim 6, wherein the controller is configured to compare the capacitance that results from applying the zero cross over voltage to the expected capacitance and update the lookup table by:
determining that the capacitance that results from applying the zero cross over voltage differs from the expected capacitance;
determining a new voltage that provides the expected capacitance; and
setting the zero cross over voltage to be the new voltage.

8. The liquid lens system of claim 7, wherein determining a new voltage that provides the expected capacitance comprises a capacitance feedback process that monitors the capacitance while changing the voltage until the expected capacitance is reached.

9. The liquid lens system of claim 1, wherein the controller is configured to reset capacitance drift before receiving the information indicative of the capacitance that results from applying the voltage differential.

10. The liquid lens system of claim 9, wherein the controller is configured to change from an initial voltage to the voltage differential to reset the capacitance drift.

11-13. (canceled)

14. The liquid lens system of claim 1, having a hysteresis of less than 0.5 diopters across an operational range of the liquid lens.

15. The liquid lens system of claim 1, wherein the voltage differential is a temperature test voltage value different from a driving voltage value that is configured to produce a target optical power for the liquid lens.

16. The liquid lens system of claim 15, wherein the temperature test voltage value is higher than the driving voltage value.

17. The liquid lens system of claim 1, wherein:
the first electrode comprises a plurality of first electrodes that are insulated from the first fluid and the second fluid; and
the controller is configured to:
apply different voltage differentials to the plurality of first electrodes;
receive information indicative of capacitances for the plurality of first electrodes that result from applying the different voltage differentials;
determine an average of the different voltage differentials applied to the plurality of first electrodes;
determine an average of the capacitances for the plurality of first electrodes; and
determine the temperature of the liquid lens based at least in part on the average of the voltage differentials and the average of the capacitances.

18. A liquid lens system comprising:
a chamber;
a first fluid in the chamber;
a second fluid in the chamber;
a first electrode insulated from the first and second fluids;
a second electrode in electrical communication with the first fluid;
a signal generator configured to apply a voltage differential between the first electrode and the second electrode, wherein a position of an interface between the first fluid and the second fluid is based at least in part on voltage differential applied between the first electrode and the second electrode; and
a controller configured to:
access a target optical power;
access a temperature of the liquid lens; and
determine a target capacitance based at least in part on the target optical power and the temperature of the liquid lens.

19. The liquid lens system of claim 18, wherein the controller is configured to:
apply a voltage differential between the first electrode and the second electrode;
receive information indicative of the capacitance that results from applying the voltage differential; and
determine the temperature of the liquid lens based at least in part on the applied voltage differential and the information indicative of the resulting capacitance.

20-21. (canceled)

22. A variable focus lens system comprising:
a variable focus lens;
one or more electrodes, wherein a focal length of the variable focus lens is adjustable by supplying voltage to the one or more electrodes;
a temperature sensor; and
a controller configured to:
apply a voltage to the one or more electrodes;
receive capacitance information indicative of a capacitance that results from the applied voltage;
receive temperature information from the temperature sensor; and
calibrate the temperature sensor based at least in part on the received temperature information, the applied voltage, and the received capacitance information.

23-27. (canceled)

28. The variable focus lens system of claim 22, wherein the controller is configured to:
apply an additional voltage to the one or more electrodes;
receive information indicative of a capacitance that results from the additional applied voltage;
compare the capacitance that results from the additional applied voltage to an expected capacitance; and
change a relationship between requested focal lengths and voltages applied based at least in part on the comparison.

29. The variable focus lens system of claim 22, wherein the controller is configured to reset capacitance drift before receiving the capacitance information.

30. The variable focus lens system of claim 22, wherein the controller is configured to operate in a calibration mode that uses capacitance feedback and in a driving mode for driving the variable focus lens that does not use capacitance feedback.
